(19) United States
(12) Patent Application Publication
(10) Pub. No.: US 2008/0126278 A1
(43) Pub. Date: May 29, 2008

(54) Parallel processing motion estimation for H.264 video codec

(76) Inventors: Alexander Bronstein, Haifa (IL); Michael Bronstein, Haifa (IL); Ron Kimmel, Haifa (IL); Selim Shlomo Rakib, Cupertino, CA (US)

Correspondence Address: RONALD CRAIG FISH, A LAW CORPORATION, PO BOX 820, LOS GATOS, CA, 95032, US

(21) Appl. No.: 11/606,401

(22) Filed: Nov. 29, 2006

(51) Int. Cl. G06F 15/18

(52) U.S. Cl. 706/17

(57) ABSTRACT

A genus of motion estimation processes is disclosed which is characterized by the following characteristics which all species in the genus will share 1) a process within this genus does not perform the motion estimation separately for each of the partitions and subpartitions defined in the H.264 standard; 2) a process within the genus computes for each motion vector in the search region the partial costs for all macroblock partitions and sub-partitions, compares them to the best partial costs found so far, and for partitions and sub-partitions having lower costs updates the corresponding best partial costs and records the current motion vectors as the one realizing them. 3) a process within the genus after finishing scanning the motion vectors in the search region, computes from the best partial costs the total costs for all possible macroblock partitioning modes and selects the one with the lowest total cost as the best macroblock partitioning mode, with the best motion vectors corresponding to each of the selected macroblock partitions and sub-partitions.

### BACKGROUND OF THE INVENTION

A digital video signal is encoded in a YCbCr format which will hereafter be referred to as YUV where Y is the luminance information (usually encoded in 8 bits) and U and V are the color channels (each usually encoded in 8 bits). The human eye is most sensitive to the luminance information as that is where the detail of edges is found.

The huge amount of data involved in representing the YUV information of a video signal cannot be transmitted or stored practically because of the sheer volume and limitations on channel bandwidth and media storage capacity. Compression is necessary. Because frames are generated so frequently, there is little difference between one frame and the next, and this is the basis of compression. Compression generally speaking encodes the differences between one frame and the next and only transmits or stores the difference information. MPEG2 and MPEG4 are examples of compression which are familiar today.

Video compression is based on removing subjective redundancy, that is, elements of the sequence that can be removed without significantly degrading the perceived visual quality.

The first redundancy is the temporal one, stemming from the similarity of consequent frames, especially at high frame rates. MPEG compression standards exploit temporal redundancy using motion-compensated prediction.

The second redundancy is spacial, stemming from the fact that many images appearing in nature have high correlation between neighboring pixels. H.264 compression takes advantage of spacial redundancy by means of intra-frame prediction. Another technique commonly employed in video compression is based on the fact the human visual system is more sensitive to inaccuracies in low frequencies, which allow to save bits by quantizing higher frequencies more aggressively. Since the human observer is by far less sensitive to spatial inaccuracies in the chromatic information, the color channels can be transmitted with reduced spatial resolution and more aggressive quantization. MPEG video compression and JPEG still image compression utilize transform-domain coding techniques to take advantage of these properties of the human visual system

In the last few years, High Definition (HD) television formats have been gaining in popularity. HD complicates the data volume problem because HD formats use even more pixels than the standard NTSC signals most people are familiar with.

The H.264 Advanced Video Codec (AVC) is the most recent standard in video compression. This standard was developed by the Joint Video Team of ITU-T and MPEG groups. It offers significantly better compression rate and quality compared to MPEG2/MPEG4. The development of this standard has occurred simultaneously with the proliferation of HD content. The H.264 standard is very computationally intensive. This computational intensity and the large frame size of HD format signals pose great challenges for real-time implementation of the H.264 codec.

To date some attempts have been made in the prior art to implement H.264 codecs on general purpose sequential processors. For example, Nokia, Apple Computer and Ateme have all attempted implementations of the H.264 standard in software on general purpose sequential computation computers or embedded systems using Digital Signal Processors. Currently, none of these systems is capable of performing real time H.264 compatible HD encoding and decoding for compression.

Parallel general purpose architectures such as Digital Signal Processors (DSPs) have been considered in the prior art for speeding up the motion estimation and deblocking processes of the compression process in papers by H. Li et al., Accelerated Motion Estimation of H.264 on Imagine Stream Processor, Porceedings of ICIAR, p. 367-374 (2005) and J. Sankaran, Loop Deblock Filtering of Block Coded Video in a Very Long Instruction Word Processor, U.S. Patent Application Publication 20050117653, (June 2005 Texas Instruments). DSPs are well adapted to doing convolution on one dimensional signals, but they lack efficiency to process two-dimensional matrices of data as required in digital video processing.

There also exist in the prior art hardware implementations custom tailored for H.264 decoders including chips by Broadcom, Conexant, Texas Instruments and Sigma Designs. Special architectures were proposed for some computationally-intensive components of the H.264 codec.

There exists a significant amount of prior works on efficient implementations of motion estimation in video codecs.

U.S. Pat. No. 5,200,820 discloses a method and apparatus for full macroblock matching motion estimation using a particular cost function. The cost for the original and the reference macroblocks is computed as the number of pixels pixels, whose difference falls below a certain threshold.

U.S. Pat. No. 5,477,272 discloses a pyramid-based motion estimation scheme, which first produces a coarse motion vector at the highest pyramid level. This estimate is used to initialize the motion vector search at lower levels. Since higher levels contain lower resolution images, the described method has a benefit on computational complexity.

U.S. Pat. No. 5,561,475 discloses an apparatus for block matching motion estimation, which first adapts the block size to the content of the encoded frame, and then searches for the best matching block in the reference frame.

U.S. Pat. No. 5,627,601 discloses a block matching motion estimation technique based on a new cost function, reflecting directly the number of bits required for the residual image transmission.

U.S. Pat. No. 5,796,434 discloses a system and a method for performing block matching motion estimation in the DCT domain.

U.S. Pat. No. 5,926,231 discloses a method and apparatus for hierarchical block matching motion estimation technique, which divides the search region into hierarchical search areas and employs gradual refinement of the found motion vector.

U.S. Pat. No. 6,014,181 discloses a block matching estimation algorithm, which established the step size in a motion search region by examining the statistical distribution of the sums of absolute difference in neighboring macroblocks.

U.S. Pat. No. 6,084,908 discloses a method and apparatus for variable size quad-tree based motion estimation. The method starts by estimating the motion vectors for the highest level in the quad-tree, and uses them as an initialization for motion vector search at lower levels. The quad-tree is then traversed bottom-up, and blocks having similar motion vectors are merged.

U.S. Pat. No. 6,175,593 discloses a method for coarse macroblock matching motion estimation followed by selectively applied bilinear interpolation to produce individual motion vectors for finer macroblock partitions.

U.S. Pat. No. 6,222,882 discloses a method for full macroblock matching motion estimation using a cost function insensitive to changes in scene illuminations.

U.S. Pat. No. 6,377,623 discloses a method and apparatus for multi-resolution full macroblock matching motion estimation. The method reduces the complexity of motion vector search by performing coarse motion estimation at lower image resolutions.

U.S. Pat. No. 6,876,702 discloses a method and apparatus for full macroblock matching motion estimation, wherein the search region for a row of macroblocks is determined according to the values of the motion vectors in the previously decoded frame.

US Patent 2004/0190616 discloses an apparatus for performing an initial block motion estimation in 16×16, 16×8, 8×16, and 8×8 partitioning modes. At a second stage, finer 4×8, 8×4, and 4×4 sub-partitioning modes are considered by performing motion vector search in a small search region, comprising motion vectors predicted from the neighboring blocks.

US Patent 2005/0013367 discloses an apparatus for performing an initial coarse block motion estimation and determining the block size associated with the coarse motion vector, followed by finer motion vector search in the proximity of the found motion vector.

US Patent 2005/0013368 discloses an apparatus for block matching motion estimation that minimizes the search memory size and external memory bandwidth.

US Patents 2005/0074064 and 2005/0089099 disclose a method for multi-resolution variable size block matching motion vector search. The method estimates two motion vector candidates at low resolution. The coarse search is followed by refinement at middle resolution, where motion vectors from neighbor macroblocks are used. Last, fine motion estimation and mode decision is performed at highest resolution.

US Patent 2005/0114093 discloses a method and apparatus for multi-resolution variable size block matching motion estimation, consisting of estimating the motion vectors for the 4×4 blocks, determining the similarity of the found vectors, and deciding the best macroblock partitioning mode according to the found similarities.

US Patent 2005/0129122 discloses a method for variable size block matching motion estimation with an early termination technique, allowing to skip motion estimation in blocks, whose estimated encoding cost is higher than the best cost found so far.

US Patent 2005/0135481 discloses a method and apparatus for efficient block matching motion estimation based on an initial motion vector prediction and scalable search range.

US Patent 2005/0141614 discloses a method and apparatus for variable size block matching motion estimation, consisting of initial coarse estimation, followed by the decision whether to further split the macroblock and estimate multiple motion vectors, based on the matching cost found at the initial stage.

US Patent 2005/0201627 discloses a method and apparatus for reducing the complexity of macroblock encoding mode decision by predicting the mode from the neighboring blocks in space and time.

US Patent 2005/0243921 discloses a method an apparatus for multiple reference frame block matching motion estimation, based on intelligent selection of reference frames and candidate motion vectors in the search region.

US Patent 2006/0002474 discloses a method, system and apparatus for variable block matching motion estimation, where only a few partitioning modes are selected when certain favorable conditions occur.

US Patent 2006/0008008 discloses a method for multi-resolution block matching motion estimation. The method includes calculating a coarse motion vector estimate at low resolution, followed by finer motion estimation in multiple partitioning modes at medium resolution, followed by refining the obtained motion vector at the highest resolution level.

US Patent 2006/0039470 discloses a method and apparatus for variable size block matching motion estimation in the H.264 video codec. The method consists of coarse-to-fine motion estimation, where each subsequent refinement stage is performed only if the estimated encoding cost is sufficiently high.

US Patent 2006/0056513 and 2006/0056708 disclose an implementation of motion estimation on graphics processing unit (GPU).

US Patent 2006/0056719 discloses a method and apparatus for variable size block matching motion estimation with an early termination technique, which stops exhaustive motion estimation prior to evaluating all the possible macroblock partitioning modes.

US Patent 2006/0062302 discloses a method for variable size block matching motion estimation, which first performs motion vector search for a limited set of block partitioning modes, computes the estimated encoding cost and decides whether to perform a finer motion vector search for the remaining modes.

US Patent 2006/0098740 discloses a method and apparatus for variable size macroblock matching motion estimation using a particular cost function, which is supposed to give a better estimate of the number of bits needed to convey the information contained in the macroblock.

US Patent 2006/0104359 discloses methods and systems for variable size block matching motion estimation. The method consists of performing an initial motion estimation in one macroblock partitioning modes, and perform refined motion vector search in other modes only if the found motion vectors are substantially different one from the other.

US Patent 2006/0109905 discloses a method and apparatus for variable size block matching motion estimation, where the macroblock partitioning mode is predicted by a Kalman filter.

US Patent 2006/0120452 discloses a method for block matching motion estimation with adaptive search region, constructed based on a statistical distribution of motion vectors in previous frames.

US Patent 2006/0120613 discloses a method for fast block matching motion estimation in multiple reference frames.

US Patent 2006/0133511 discloses a method for variable size block matching motion estimation with fast mode selection, based on the encoding modes of the neighboring blocks.

US Patent 2006/0165175 discloses a method for block matching motion estimation, which reduces the search complexity by skipping candidate motion vectors in the search region.

US Patent 2006/0193386 discloses methods for fast block partitioning mode decision, based on neighbor blocks in space and in time.

US Patent 2006/0198439 discloses a method and apparatus for full macroblock matching motion estimation using a cost function aimed to better estimate the eventual number of bits required to transmit the information contained in the macroblock.

US Patent 2006/0198445 discloses a method and apparatus for performing block matching motion estimation, where a first coarse motion estimation stage is performed based on a predicted motion vector, followed by a finer sub-pixel motion estimation stage, based on a prediction of the sub-pixel motion vector.

### The Basics of H.264 Video Compression and Reconstruction

Compression is done on video frames using 16×16 luminance pixel blocks called macroblocks and 8×8 Cb color pixel macroblocks and 8×8 Cr color pixel macroblocks. The Cb and Cr color channels are also referred to as the U and V channels in YUV parlance. Each luminance and Cb or Cr pixel is 8 bits in length.

Referring to FIG. 1, there is shown a block diagram of a prior art video data encoder to compress raw video pixel luminance data down to a smaller size. Chrominance data is compressed in a very similar manner and will not be discussed in detail. The raw video input pixel data in RGB format arrives on line 10. RGB format signals have redundancy between the red, green and blue channels, so converter 12 converts this colorspace to a stream of pixel data 14 in YCbCr format (referred to hereafter as YUV). The Y pixels are luminance only and have no color information. The color information is contained in the Cb and Cr channels. Since the eye is less sensitive to color changes, the Cb and Cr channels are sampled at one fourth the resolution of the Y channel. A buffer 16 stores a frame of YUV data. This original frame data is applied on line 18 to summer 20. The other input 22 to the summer is the predicted frame which is generated by predictor 24 from a previous frame of pixels stored in buffer 26.

Video frames happen very fast, so there is little difference between adjacent frames. This is the basic idea of compression. Since there is so much similarity between adjacent frames in time, only the differences need to be transmitted. All the video compression standards, including H.264, operate on this same basic principle. The basic idea is to encode the differences between frames and only transmit the differences. This is done by performing motion estimation and then transmitting motion vectors. To do this, a predicted frame is constructed by predictor 24 from a previous or reference frame stored in buffer 26. The predictor has many prior art implementations. The predicted frame is supplied on line 22 to summer 20 which subtracts the predicted frame from the original frame on line 18 and outputs the luminance difference between each pixel in the frame to be encoded (on line 18) and the predicted frame (on line 22). The collection of difference numbers (one for each pixel in the original frame) is the error image on line 28.

MPEG4 is a long-lasting video coding standard, whereas the Advanced Video Codec (AVC), commonly known as H.264 is a stand-alone video coding standard, though included as annex 10 of the MPEG4 format. Hence, when we say MPEG4 we are not talking about H.264.

In MPEG2 and MPEG4, prediction was only temporal. There are two types of prediction: 1) interframe or P-Block prediction; and 2) intraframe or I-Block prediction. Each predicted frame was predicted from a preceding frame in time (previous frame in buffer 26) which is called the reference frame. In P-Block prediction, each macroblock, or some subdivision thereof, of the predicted frame is predicted using a motion vector and residual image. The motion vector points to the origin of a similarly sized macroblock or subdivision thereof in the reference frame which has the closest set of pixels in terms of luminance errors. The residual image is then calculated using this reference macroblock by subtracting the luminance values in the reference macroblock or subdivision thereof from the luminance values of the pixels in the corresponding macroblock or subdivision thereof in the frame being encoded. A similar process is performed for the chrominance channel.

The residual image is then encoded in encoder 30 and the encoded data on line 32 is transmitted to a decoder elsewhere or some media for storage. Encoder 30 does a Discrete Cosine Transform (DCT) on the error image data to convert the functions defined by the error image samples into the frequency domain. That is, the integer luminance difference numbers of the error image define a function in the time domain (because the pixels are raster scanned sequentially) which can be transformed to the frequency domain using DCT transformation for greater compression efficiency and fewer artifacts. The DCT transformation outputs integer coefficients that define the amplitude of each of a plurality of different frequency components, which, when added together, would reconstitute the original time domain function. Each coefficient is quantized, i.e., only some number of the most significant bits are kept of each coefficient and the rest are discarded. This cause losses in the original picture quality, but makes the transmitted signal more compact without significant visual impairment of the reconstructed picture. For the coefficients of the higher frequency components, more aggressive quantization can be performed (fewer bits kept) because the human eye is less sensitive to the higher frequencies. More bits are kept for the DC (zero frequency) and lower frequency components because of the eye's higher sensitivity to lower frequencies.

All the circuitry inside box 34 is the encoder, but the predicted frame on line 22 is generated by a decoder 36 within the encoder.

FIG. 2 is a block diagram of the decoder circuitry which decompresses the received compressed signal on line 38 and outputs the reconstructed frame on line 42. Decoder 40 peforms an inverse DCT and inverse quantization on the incoming compressed data on line 38. This results in a reconstructed error image on line 44. This is applied to summer 46 which adds each error image pixel to the corresponding pixel in the predicted frame on line 48. The predicted frame is exactly the same predicted frame as was created on line 22 in FIG. 1 because the decoder 36 in FIG. 1 is the same decoder as the circuitry within box 50 in FIG. 2. The error plus the predicted pixel equals the original pixel luminance.

In H.264 encoding, like previous encoding standards, there are two types of frames in a compressed video stream: I-frames and P-frames. The difference is the form of prediction used. Interprediction based upon previous frame gives P-blocks. Basically, each block is predicted based upon a region of similar pixels of the same size in a previous reference frame. Intraprediction gives I-blocks where prediction from within the same frame where each I-block has its pixel values predicted from neighboring pixels on its borders in other blocks. This form of prediction did not exist in previous compressions schemes although I-frames did exist in MPEG2. MPEG2 I-frames did not use prediction at all—the pixel values were subjected to a DCT transform and then quantized and transmitted.

In H.264 compression, frames can be divided into slices and each slice can be divided into macroblocks which can themselves be divided further into partitions. I-frames and I-blocks in both MPEG2 and H.264 have no dependence upon any previous frame and can contain only intra macroblocks (encoded in intraframe mode without reference to a previous reference frame).

P-frames in H.264 can contain either I-blocks which are encoded with intraprediction or P-blocks which are encoded with interprediction (motion vectors and error pixel values). In other words, P-blocks have dependence upon a previous frame because their encoding involves the use of motion vectors calculated based upon a previous frame.

In a P-frame, each P-block (or each subdivision thereof) has a motion vector which points to the same size block of pixels in a previous frame using a Cartesian x,y coordinate set. The same size block of pixels pointed to by the motion vector is the set of pixels which are the closest in luminance values to the pixel luminance values of the macroblock to be encoded. The differences between the reference macroblock luminance values and the P-block luminance values are encoded as a macroblock of error values which are integers which range from −255 to +255. The data transmitted for the compressed macroblock is these error values and the motion vector. The motion vector points to the set of pixels in the reference frame which will be the predicted pixel values in the block being reconstructed in the decoder.

The differences between the luma values of the pixels of the block being encoded and the reference pixels are then encoded using DCT and quantization. In the preferred embodiment, the macroblock of error values is divided into four 4×4 tiles of error numbers. Each error number is the number of bits it takes to represent an integer ranging from −255 to +255. Chroma encoding is slightly different because the macroblocks are only half the resolution of the luma macroblocks.

The DCT, and in particular the DCT-II, is often used in signal and image processing, especially for lossy data compression, because it has a strong “energy compaction” property: most of the signal information tends to be concentrated in a few low-frequency components of the DCT. This allows compression by quantization because more bits of the less significant high frequency components can be removed and more bits of the more significant low frequency components can be kept. In digital signal processing, quantization is the process of approximating a continuous range of values (or a very large set of possible discrete values) by a relatively-small set of discrete symbols or integer values. Basically, it is truncation of bits and keeping only a selected number of the most significant bits. For example, suppose 16 bits are output for every frequency component coefficient. For the less significant higher frequency components, only two bits might be kept, whereas for the most significant component, the DC component, all 16 bits might be kept. Typically, quantization is done by using a quantization mask which is used to multiply the output matrix of the DCT transform. The quantization mask does scaling so that more bits of the lower frequency components will be retained.

The discrete cosine transform is defined mathematically as follows.

$$b ( u , v ) = {\sum }_{x} {\sum }_{y} a ( x , y ) cos \frac{ux 2 π}{4} cos \frac{vy 2 π}{4} \qquad ( 1 )$$

As an example of a DCT transform, a DCT is used in JPEG image compression, MJPEG, MPEG, and DV video compression. In these compression schemes, the two-dimensional DCT-II of N×N blocks is computed and the results are quantized and entropy coded. In this example, N is typically 8 so an 8×8 block of error numbers is the input to the transform, and the DCT-II formula is applied to each row and column of the block. The result is an 8×8 transform coefficient array in which the (0,0) element is the DC (zero-frequency) component and entries with increasing vertical and horizontal index values represent higher vertical and horizontal spatial frequencies. The DC component contains the most information so in more aggressive quantization, the bits required to express the higher frequency coefficients can be discarded.

Typically, the DC coefficients that result from the DCT transform are separately extracted into a 4×4 tile for each 4×4 matrix of DCT coefficients, and these 16 DC coefficients are themselves transformed using a Hadamard transform.

In the process of the invention, parallel processing to do motion vector computation is performed on any parallel processor, but the preferred processor is a cluster of eight computational units each of which is optimized for 4×4 matrix math. Therefore, the preferred input matrix size is 4×4, and the Discrete Cosine Transform (or one of its equivalents), converts the 4×4 matrix of error values into a 4×4 matrix of coefficients of different frequency components. Each row of error numbers represents a 4 element vector which is input to the DCT and results in a 4×4 matrix of frequency components at the output.

P-block encoding is the form of compression that is used most because it uses the fewest bits.

Motion estimation is the process of finding the set of pixels in the reference frame that reduces the discrepancy in luma values between the P-block being encoded and the reference block in the reference frame. It is essentially a searching process to find the block of pixels in the reference frame which is closest to the block of pixels to be compressed (encoded). A motion vector is essentially a pointer to how the set of pixels in the reference frame were displaced to form another set of pixels in the frame being encoded with changes of intensity of individual pixels being encoded as the error number image.

Motion estimation is one of the most computationally intensive parts of the process of compressing successive video frames using P frames, especially in H.264 compression since resolution for the motion vectors can go down to ¼ pixel. Therefore, there exists a need for a highly parallel architecture and processes for using this parallel processing architecture and the data independency of macroblocks in video frames to do the searching necessary to find the best motion vectors both for H.264 compression and other compression standards such as MPEG2/MPEG4 etc. Finding the best motion vectors is important because when the reference pixels are close in values to their corresponding pixels in the frame to be compressed, the error numbers are smaller and it takes fewer bits to represent them.

### BRIEF DESCRIPTION OF THE DRAWINGS

FIG. 1 is a block diagram of a prior art video data encoder to compress raw video pixel luminance data down to a smaller size.

FIG. 2 is a block diagram of the decoder circuitry which decompresses the received compressed signal on line 38 and outputs the reconstructed frame on line 42.

FIG. 3 illustrates the concept of a motion vector.

FIG. 4 is a high level block diagram of the preferred parallel processing Avior architecture upon which the process of the invention can be carried out.

FIG. 5 shows the subject macroblock, the predicted motion vector and the search region for the correct motion vector as part of the process of minimizing equation (2).

FIG. 6 is a flowchart of the broad process for finding the motion vector or motion vectors and the partition which minimizes the value for Equation (2) below thereby approaching the minimum number of bits need to transmit a compressed macroblock.

FIG. 7 illustrates an example of what might be computed for a particular macroblock for two searches and computations of Equation (2) carried out simultaneously by two computational clusters in two separate segments 92 and 94 of the search region 72.

FIG. 8, comprised of FIGS. 8(a) through 8(d), illustrates the concepts employed in selecting a search region from the reference frame with the destination pixel coordinates of the predicted motion vector established in the mid section of the search region.

FIG. 9, comprised of FIGS. 9(a), 9(b), 9(c) and 9(d), shows all the different possible partitions and sub-partitions for a 16×16 tile in the search area.

FIG. 10 schematically illustrates this process of computing the total cost of the macroblock partition candidates and picking the best one.

FIG. 11 is a diagram which symbolically illustrates the process of picking the lowest cost macroblock sub-partition for each of the four quadrants of a 16×16 reference tile from the best-cost vector.

FIG. 12 is a diagram which illustrates the SAD calculation using 4×4 pixel arrays from the 16×16 pixel reference tile 130 and the original 16×6 pixel macroblock array 200 to be encoded.

FIGS. 13A and 13B together comprise a flowchart of the parallel processing version of the coarse motion estimation process to find the lowest cost partition or subpartition of the reference macroblock to encode the macroblock to be encoded.

FIG. 14, comprised of FIGS. 14(a) through 14(s), is a diagram illustrating how the process of calculating SAD and overhead costs for various partition and sub-partition combinations works and how the mask vector is generated and the best-cost vector is updated using the mask vector.

FIG. 15 shows a lowest cost partition and sub-partition selection where each of the lowest cost elements of a sub-partition has a different MVD motion vector.

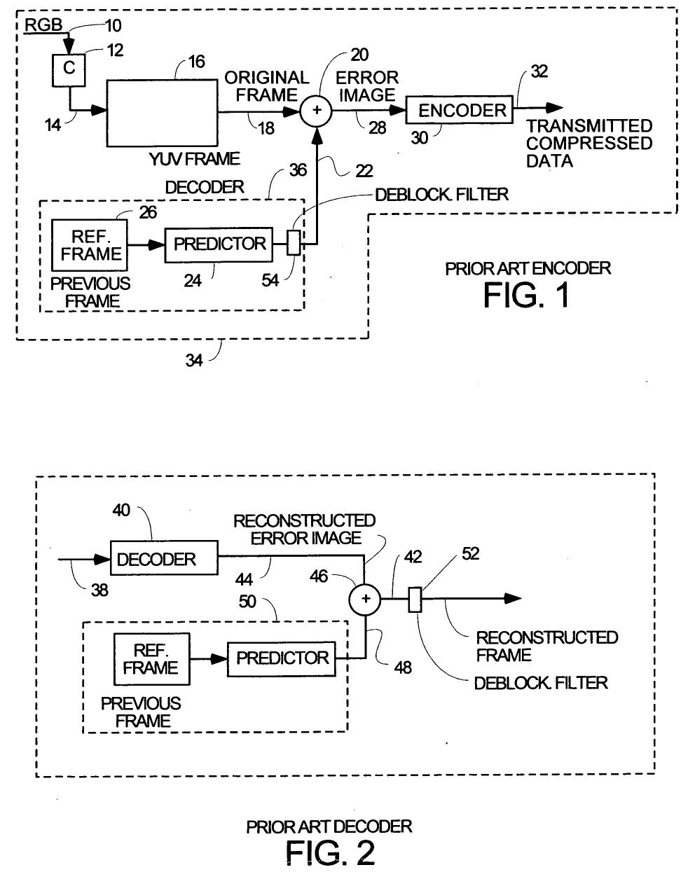

### SUMMARY OF THE INVENTION

The invention claimed herein is related to motion estimation consisting of finding the lowest cost partition or sub-partition and the corresponding motion vectors of a macroblock at any pixel precision level although at pixel precision levels of a fraction of a pixel, pixel values in the reference macroblock will have to be interpolated from neighboring pixel values.

A genus of motion estimation processes is disclosed which is characterized by the following characteristics which all species in the genus will share 1) a process within this genus does not perform-the motion estimation separately for each of the partitions and subpartitions; 2) a process within the genus computes for each motion vector in the search region the partial costs for all macroblock partitions and sub-partitions, compares them to the best partial costs found so far, and for partitions and sub-partitions having lower costs, updates the corresponding best partial costs and records the current motion vector(s) as the one or ones realizing the lowest cost or costs. 3) a process within the genus, after finishing scanning the motion vectors in the search region, computes from the best partial costs the total costs (sub-partitions have multiple elements each of which has a cost which must be totalled to arrive at the total cost of the sub-partition) for all possible macroblock partitioning modes and selects the one or ones with the lowest total cost as the best macroblock partitioning mode, and selects the best motion vector(s) corresponding to the selected macroblock partitions and sub-partitions.

Many different species of processes that share the above noted characteristics fall within the scope of the invention. Computers that are programmed with software that causes the computers to carry out any of these species also fall within the scope of the invention as does computer-readable mediums which have stored thereon computer-readable instructions which, when executed by a computer, cause the computer to perform any of the processes falling within the definition of the genus.

In the preferred embodiment, 16×16 macroblocks are used, but other species within the genus may use some other size of macroblock. In the preferred embodiment, each macrobock is divided up into non-overlapping 4×4 tiles. In other species, other sizes of non-overlapping tiles may be used. In the preferred embodiment, a SAD (Sum of Absolute Differences) for each 4×4 tile is used as its estimated encoding cost. In other embodiments, some other measure of cost of encoding other than SAD may be used. In the preferred embodiment, all or part of the partitions and sub-partitions defined in the H.264 standard are used in the search algorithm to find the lowest cost partition and/or sub-partitions. In other embodiments, some other partitions and sub-partitions other than those defined in the H.264 standard may be used.

The purpose of the motion estimation algorithm in the preferred embodiment is to form a motion-compensated prediction of a given 16×16 macroblock from a reference picture, so as to minimize the number of bits needed for its encoding. For this purpose, the macroblock may be partitioned into smaller tiles, for each of which a separate motion vector is found. The main novelty of the present invention is the simultaneous computation of the best motion vectors for all possible macroblock partitions and sub-partitions supported by the H.264 standard.

First, the causal neighboring macroblocks of the currently encoded macroblock are used to form the predicted motion vector as defined in the standard. The predicted motion vector is used as the center of the search region. We henceforth describe the motion estimation algorithm performed on a single processing unit; if more processing units are available, the search region is divided between them and the same algorithm is applied simultaneously to the different parts of the search region. Unless stated otherwise, only the luma channel is considered.

The search region is traversed in raster scan order with an integer step. Motion vectors in the search region are represented as motion vector differences (MVD) relative to the predicted motion vector.

For each MVD in the search region, a 16×16 reference macroblock, whose upper left corner (origin) is pointed by that MVD is extracted from the reference frame. Both the currently encoded macroblock and the reference macroblock are divided into 16 4×4 tiles. For each pair of corresponding tiles, a differential cost (such as an SAD or any other cost measure suitable to those skilled in the art) is computed, forming a differential cost matrix. The differential cost must satisfy the additivity property, meaning that the cost of a whole is equal to the sum of the costs of its non-overlapping parts. For example, the differential cost may be the sum of absolute differences (SAD—sum of absolute difference in luma value between pixels in the reference tile and the luma values of the corresponding pixels of the tile from the macroblock to be encoded).

In addition, the approximate overhead for transmitting the MVD is computed; since the traversal order is known a priori, the overheads for each of the motion vectors in the search region can be pre-computed and tabulated so that it can be pre-fetched thereby avoiding the machine cycles of a table lookup operation.

A cost vector of partial costs, corresponding to all the partitions and sub-partitions of the reference macroblock is computed by summing the corresponding elements of the differential cost matrix. For example, if the macroblock size is 16×16 and the allowed partitioning modes are two 16×8 partitions, or two 8×16 partitions, or four 8×8 partitions, and the selected tile size is 4×4, the first element of the cost vector corresponding to the 16×16 partition is obtained by summing all the elements of the differential cost matrix; the second and the third elements of the cost vector corresponding to the upper and the lower parts of the 16×8 partition are obtained by summing the first two and the last two rows of the SAD matrix, respectively. The MVD coding overhead is added to each of the partial cost vector elements such that each element of the partial cost vector stores the total SAD and MVD overhead cost of the particular partition or sub-partition that element represents. For example, the vector contains 41 elements to account for all possible macroblock partitions and sub-partitions supported by the H.264 standard, and 9 elements if sub-partitions of the 8×8 partition are ignored.

The algorithm of a process within the genus of the invention stores another vector of the same length, containing the best set of partial costs (lowest costs) found so far and two additional vectors of the same length, containing the corresponding x- and y-coordinates of the motion vector differences (these two vectors are henceforth referred to as best_MVDx and best_MVDy, respectively). The best cost vector is initialized by maximum cost values, which in 16-bit arithmetic corresponds to 65,535.

For each of the scanned motion vectors in the search region, the partial cost vector is compared to the best cost vector. Elements in the best cost vector whose value is higher than that of the corresponding elements in the partial cost vector are replaced by the corresponding partial cost values. The corresponding elements of the best_MVDx and best_MVDy vectors are set to the x- and y-coordinate of the current MVD (the MVD of the partition or sub-partition whose partial costs were substituted into the best cost vector).

After all MVDs in the search region are scanned, the best cost vector contains the lowest partial costs of all macroblock partitions and sub-partitions, and best_MVDx and best_MVDy contain the MVDs realizing the best partial costs. For example, the 16×8 sub-partitition has two elements in the best cost vector, the SAD plus MVD overhead cost of each of these two elements being stored in two different elements of the best cost vector dedicated to this particular sub-partition. Elements of the best cost vector are summed to form the total costs for each of the macroblock partitions and sub-partitions supported by the H.264 standard. For example, the total cost of the 16×16 partition is simply the first vector element; the total cost of the 16×8 partition is the sum of the second and the third elements each of which stores the SAD plus MVD overhead cost of one of the two elements of this sub-partition, etc. The partition with the lowest total cost is deemed the best partition. The corresponding MVDs are extracted from best_MVDx and best_MVDy.

The search process to find the lowest cost partition or sub-partition(s) of the reference macroblock in the entire search area is completed by performing the following steps:

1) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions;

2) in each computation unit, selecting the macroblock partition or sub-partition(s) and the corresponding MVD motion vectors that yield the lowest total cost;

3) among the macroblock partition or sub-partitions selected in step 2 by all computational units, selecting the macroblock partition or sub-partition(s) and the corresponding MVD motion vectors that yield the lowest total cost. The described process can be used as a single-stage motion estimation, or can be followed by one or more fine-tuning stages. Fine tuning with sub-pixel precision can be done around the selected MVD(s) which point to the lowest cost partition or sub-partition(s), but that is not part of the scope of this invention. In an alternative embodiment, instead of dividing the 16×16 reference macroblock up into 16 4×4 tiles, the absolute difference at each pixel location in the 16×16 reference macroblock is calculated at the reference macroblock pointed to by each candidate MVD. The cost (such as SAD cost or other suitable cost measure) for each partition and sub-partition (such as those supported by the H.264 specification) is then calculated (such as by summing up the absolute differences at the pixels within each partition and each element of a sub-partition) and recording the total cost in the appropriate elements of the partial cost vector. In some embodiments, within this class of processes, the cost so calculated will be incremented by adding the MVD overhead costs to each element. All other steps are the same. We do not perform motion estimation separately for each of the partitions and sub-partitions, as the competing algorithms do, but rather compute the partial costs for all partitions simultaneously. In the preferred embodiment, this is done by dividing the 16×16 reference block into 4×4 tiles and computing the SAD of each 4×4 tile simultaneously. These computed SADs are recorded in a SAD matrix, and the SAD matrix is computed before the partial cost of any partition or sub-partition is calculated using this SAD matrix. In an alternative embodiment, the total SAD plus MVD overhead cost for each partition and sub-partition at each candidate MVD may be calculated by a separate computational unit dedicated to each partition or sub-partition, and the results are compared by one or more computational units to find the lowest cost partition or sub-partition(s).

After all the MV candidate motion vectors in the search sub-region are exhausted, we only have to select the lowest cost partition or sub-partition(s) and the MVD(s) that point to the lowest total cost partition or sub-partitions. Once the lowest cost partition or sub-partition(s) are selected, the corresponding MVD motion vectors are readily available because they are recorded in the as best_MVDx and best_MVDy vectors. The original macroblock can then be encoded using these results.

### DETAILED DESCRIPTION OF THE PREFERRED EMBODIMENT

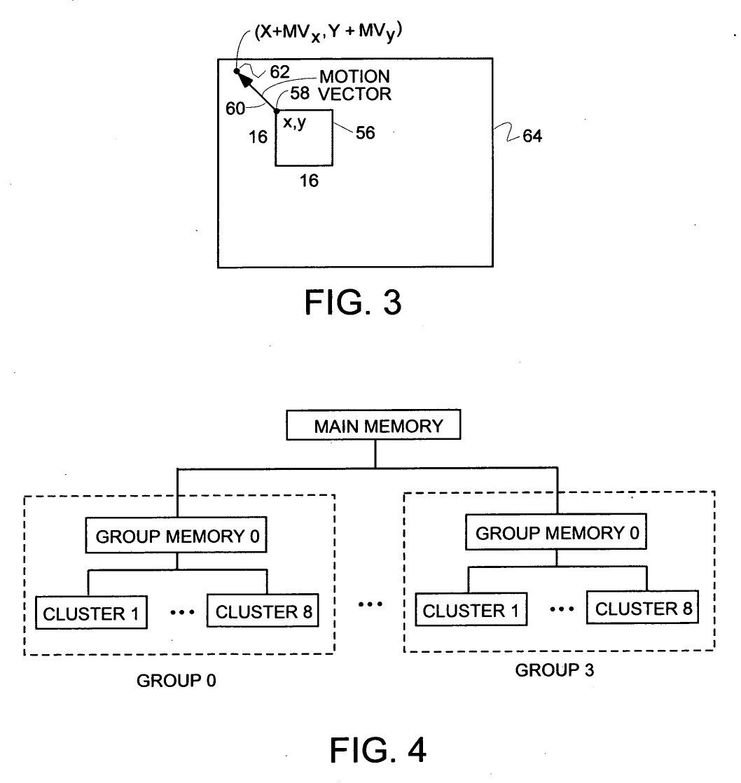

FIG. 3 illustrates the concept of a motion vector. A 16 pixel by 16 pixel macroblock 56 has an origin (x,y) at 58. A motion vector 60 points to a (x,y) coordinate in a reference frame (not shown but the reference frame can be imagined as a transparency lying below of the frame 64) which is the origin of a 16×16 block of pixels which are closest in luma values to the luma values of the pixels in macroblock 56. The coordinates on the origin of the block of pixels pointed to by the motion vector are (x+MVₓ, y+MV_{y}). Multiple reference frames are allowed in H.264. Only one reference frame per macroblock is allowrd. The motion estimation process described herein is equally applicable to multiple reference frames by extending the search region across several frames.

Motion estimation is the process of finding the best motion vector which points to a block of pixels in the reference frame which is closest to the pixels in the block to be encoded.

A 16×16 macroblock can be split under the H.264 standard into multiple sub-blocks (sub-blocks are also referred to herein as tiles or sub-partitions), and each sub-block has its own motion vector. For example, a 16×16 macroblock can be split into two 16×8 sub-blocks or four 8×8 sub-blocks. Each 8×8 sub-block can be split into four 4×4 sub-blocks. Therefore, the worse case scenario for a subdivided macroblock is that it will be divided into 16 4×4 sub-blocks and have 16 motion vectors which will need to be computed.

Each of the motion vectors need to be encoded and transmitted. Recall that the motion vector points to a set of pixels in the reference frame which will serve as the predicted macroblock or subblock. The difference between the pixel values in the block of pixels in the reference frame pointed to by the motion vector and the actual values of the pixels in the macroblock or sub-block being encoded needs to be encoded and transmitted. This set of differences between the set of pixels pointed to by the motion vector and the same size set of pixels to be encoded in the current frame is called the error or residual image. The larger the errors in the error image that need to be encoded, the more bits it usually takes to encode them. This error is called the prediction error, and it is desirable to keep it small so that it takes less bits to transmit it.

There is a cost function trade-off involving the number of sub-blocks into which a macroblock is divided in order to minimize the errors in the error image and the overhead of breaking a macroblock down into sub-blocks and having to transmit macroblock partitiong mode and multiple motion vectors. The tradeoff is between the number of bits needed to encode the residual image and the number of bits needed to encode the motion vector and partitioning mode. One way to find a suitable trade-off is brute force by doing motion estimation for each different sub-blocks into which a macroblock may be broken and calculating the number of bits it takes to encode the required motion vectors and error images for each different combination, and selecting the combination of sub-blocks forming a valid macroblock partitioning, which results in the fewest number of bits to encode the motion vectors and the error images for each sub-block. This is a large amount of computation and is difficult to do in real time.

A more practical approach is a heuristic approach which is quite reliable in predicting with quite good correlation to the actual number of bits required to transmit the motion vectors and the error image. This approach, in part, finds the minimum of the Sum of Absolute Differences (SAD) which is a measure of the error between the predicted macroblock and the macroblock to be encoded (compressed).

The SAD is calculated by subtracting the luma value of the pixel at row one, column one of the reference macroblock from the luma value of the pixel at row one, column one of the original macroblock to be encoded. This absolute value of the said difference is stored in memory. This process is repeated for the pixels at row one, column two, and the absolute values of the difference is added to the absolute value of the difference stored for the pixels at row one, column one of the reference block and the original block. This process is repeated until all pixels in the reference macroblock pointed to by the motion vector have had their luma values subtracted from the luma values of the corresponding pixels in the original frame. A macroblock has 256 pixels, but SAD can be calculated for smaller tiles as well.

The SAD is higher when coarser macroblock partitioning is used because some small motion will be likely to be missed which causes the error numbers at the pixels where the motion is displayed to be higher thereby raising the SAD. With finer granularity of sub-partitioning, the total SAD for the 16×16 macroblock is lower because the predicted pixel luma values of the smaller sub-blocks is much more likely to be closer to the luma values of the corresponding pixels in the original block to be encoded. In other words, the more a macroblock is divided and the more motion vectors found for it, the more accurate is the prediction and the lower is the SAD. But there is an overhead cost associated with more sub-division which must be counted.

So an equation that expresses the cost function trade-off relationship is:

min SAD+λ*bits(MVD) (2)

where min SAD is the minimum SAD for the particular macroblock partitioning mode chosen as opposed to all the other partitioning modes options tried, and

where λ* bits(MVD) is a constant times the motion vector difference (with respect to the predicted motion vector for that particular partition), and is the fixed overhead cost of the particular macroblock partitioning mode and motion vectors chosen (when there are more motion vectors because of sub-divison, more bits are consumed to transmit them; larger MVDs also consume more bits to encode). λ is a constant for each macroblock and is bitrate or quality dependent. Motion vectors can be predicted based upon neighboring motion vectors so MVD is the error between the predicted motion vector and the actual motion vector of a sub-block or macroblock. The MVD is the difference vector between the predicted motion vector and the actual motion vector. H.264 always transmits MVD difference vectors based upon motion vector prediction.

Basically, the process teachings of the invention are a process to find the sub-block partition combination which minimizes Equation (2). Any process which finds the sub-block partition and motion vectors which minimize Equation (2) is potentially within the teachings of the invention. The preferred embodiment breaks the 16×16 reference macroblock into 16 4×4 tiles and calculates the SAD of each one and stores that SAD for each 4×4 tile in an 4×4 SAD matrix. For each candidate partition or sub-partition, the SAD costs of the appropriate tiles are added together and stored in the partial cost vector and summed with the MVD encoding overhead costs. This partial cost vector is then compared to the best cost vector, and a binary mask is prepared. Then the mask is used to substitute any partial cost which is lower than the corresponding element of the best cost vector into the best cost vector and the x, y coordinates of the origins of the sub-partitions are substituted into the appropriate elements of the of the best_MVDx and best_MVDy vectors. The lowest cost partition or lowest cost sub-partitions for each quadrant are then selected. In the preferred embodiment, all this processing is done on a single processor of a multi-processor parallel processing architecture computer. Hereafter, the term cluster should be understood as referring to a single processor or CPU of a multi-processor parallel processing architecture computer and may be used instead of processor or CPU from time to time. The remaining processors are occupied with the same process for different parts of the motion search region.

In a first alternative embodiments, a single processor can calculate the SAD of each partition and sub-partition of each quadrant separately without first dividing the 16×16 reference macroblock into 16 4×4 tiles. This is slower since there is repetition in calculating SAD costs for each different partition or sub-partition.

In a second alternative embodiment, a separate processor could be assigned to calculate the SAD and add the MVD overhead cost for a particular partition or sub-partition or sub-group of partitions or sub-partitions, and store the total cost results in the-cost vector and then do the comparison and substitution. In this embodiment, the SAD costs and addition of the MVD overhead for each partition and sub-partition are calculated simultaneously in different processors and the comparison and substitution is done in separate processors simultaneously, and the selection of the lowest cost partition or sub-partition for each quadrant is done in a single processor.

Sub-partitioning to reduce the SAD is desirable, because if the predicted block is very close in pixel luma values to the corresponding set of pixel, the residual image magnitudes will be smaller and carry less information. Smaller. SAD magnitudes mean less information has to be transmitted.

The goal of the process genus taught herein is to minimize both the SAD by sub-division as well as the overhead cost resulting from the sub-division. Rate distortion is a trade off concept which entails maximizing the quality of the image resulting from the bits of the compressed image which are transmitted when the bit transmission rate is fixed, such as in direct broadcast satellite or cable programming, or which entails minimizing the consumed bandwidth of transmission or making the file size as small as possible on a storage media for a fixed quality such as DVD quality.

A genus of processes is taught herein to calculate the SAD for each of a number of different partition and sub-partition options and to calculate the MVD overhead cost of each and decide which particular macroblock partitioning mode yields the lowest cost. If, using the teachings of the invention, the minimum is found for Equation (2), then it is highly probable that the quality of the transmitted image will be better for a fixed bandwidth; and (2) for a fixed quality image, fewer bits will have to be transmitted or stored.

### The Motion Estimation Algorithm

One possibility is to perform an exhaustive search which tries each possible origin in the reference frame for each motion vector and for each possible sub-partition of the subject macroblock and calculates the value of Equation (2) for each possibility and chooses the one with the minimum value. That is a great deal of computation complicated by the fact that it gets multiplied by the number of macroblocks in a high definition picture which is a large number of macroblocks.

The preferred embodiment of the invention is to efficiently and rapidly find a motion vector or multiple motion vectors and a partition or one or more sub-partitions for the subject macroblock which minimizes the value of Equation (2).

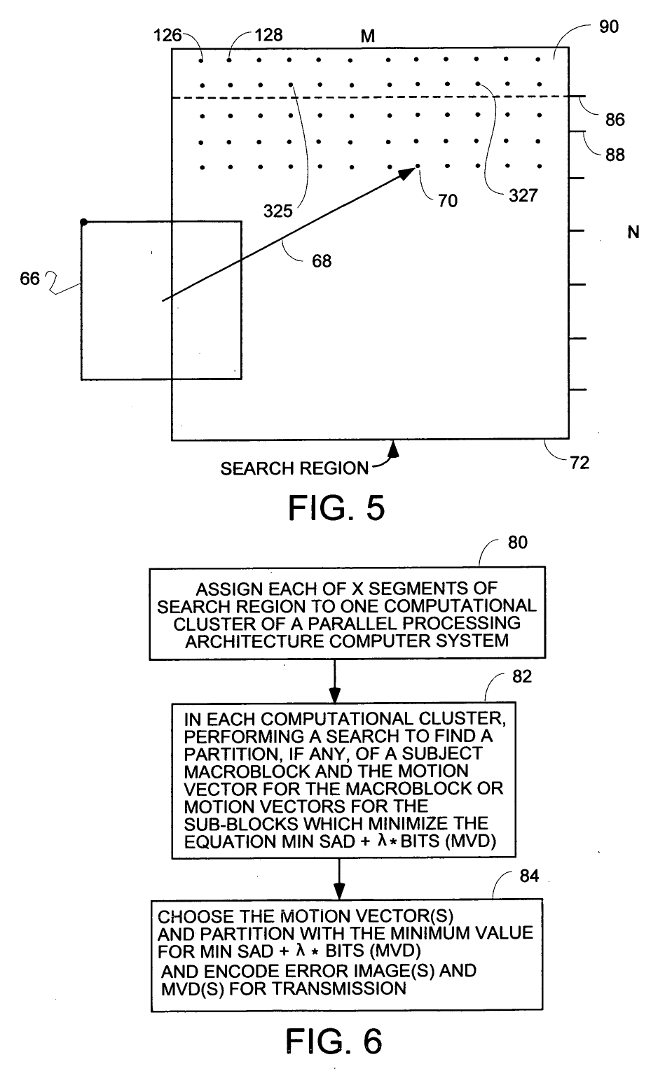

The Motion Estimation algorithm is explained starting at FIG. 5 which shows the subject macroblock, the predicted motion vector and the search region for the correct motion vector as part of the process of minimizing Equation (2). The subject macroblock to be encoded 66 has an estimated motion vector 68 estimated from motion vectors of neighboring macroblocks (not shown). The motion vector terminates at a pixel 70 in search region 72. The search region 72 is a two-dimensional M×N pixel array which is typically at least 32×32 pixels in size for High Definition pictures. The dots inside the search region represent pixel locations where motion vectors participating in the search might terminate. The H.264 standard specifies resolution of motion vectors down to ¼ pixel, so each of the dots only represents one of sixteen possible termination points per pixel for the motion vector. When integer motion vector search is performed, candidate MVDs terminate on every other pixel in each row of pixels, or a subset thereof (e.g. even pixels in every even row), but the process described herein can also be used to search for lower cost partitions at any one of the sixteen possible termination points around each pixel although pixel interpolation would be required. Thus, if search area 72 were a 16×16 pixel array, the total number of possible origins for the correct motion vector that must be considered as to their effect on Equation (2) is 16×16×16. This is because each pixel has a 4×4 array of quarter-pixel points around it where the motion vector could terminate.

In addition to all these possible motion vector termination points, there must also be considered the effect of all the possible partitions of macroblock 66 into sub-blocks. Each sub-block will have its own motion vector which also can terminate on any one of the 16×16×16 possible termination points. If the search area is 32×32, the problem becomes even bigger. It is clear that the number of possible combinations which must be searched to find the right combination of subdivision and motion vector termination points is huge. Exhaustive search is not a viable option. However, the more precise is the estimate, the fewer is the number of bits that must be sent. The invention makes use of the assumption that the SAD reflects the amount of bits that must be used to send the error image which is quite close to reality. The invention also makes the assumption that the second term in Equation (2) is the amount of bits needed to send the motion vector differences. Minimizing Equation (2) then comes pretty close to minimizing the number of bits that must be sent to transmit the compressed macroblock. This means one can achieve better picture quality for the same bandwidth because you can use finer quantization, or you can achieve less bandwidth to transmit the same quality picture.

To speed up the process of finding the minimum value for Equation (2), a parallel processor can be used and the search area can be divided into the number of areas for which there are computational units. FIG. 6 is a flowchart of the broad process for finding the motion vector or motion vectors and the partition which minimizes the value for Equation (2) below thereby approaching the minimum number of bits need to transmit a compressed macroblock. The first step, represented by block 80 is to assign each of X segments of the search region to one processor or CPU of a parallel processing computer. X is the number of segments into which the search region was divided and is equal to the number of computational clusters available in the parallel processing computer system chosen. Any parallel processing computer having multiple computational clusters, each capable of performing independent searches for the partition and motion vector(s) which minimize Equation (2) will suffice to practice the invention. In FIG. 5, tick marks 86 and 88 represent two of the boundaries of eight horizontal band segments into which search region 72 is divided in one example. The number of segments can be any number equal to the number of available computational clusters. Eight is chosen in this example because that is the number of available computational clusters in one group of the preferred Avior parallel processing architecture shown in FIG. 4. The segment represented by horizontal band 90 is assigned to one of the eight computational clusters. Any parallel processing architecture computer or gate array or ASIC which is programmed or “hardwired” (netlist structures device to perform any process within the genus) to perform any process within the genus of processes described herein will suffice to practice the invention.

Step 82 represents the actual search in each segment of the search region. Specifically, each computational unit performs a search, preferably the search algorithm described further below, to find the motion vector or vectors and the partition that minimizes Equation (2) for the particular portion of the search region processed by that computational unit. In other words, the best partition into multiple sub-blocks (or no partition at all if that is best) is found that minimizes the value of Equation (2), and the motion vector for each sub-block is found which minimizes the value of Equation (2). Each computational cluster carries out its search in its assigned sector of the search region independently of the rest of the computational clusters.

When all the computational units are done, there will be X candidates for the value of Equation (2), each calculated by one computational unit and each based upon some termination point(s) in the corresponding search area and the motion vector(s) and partitions calculated by the computational unit for the corresponding search area. The final motion vector(s) and partition is determined by selecting as those minimizing the cost value in Equation (2) from the X candidates, as symbolized by step 84. This speeds up the process of finding the correct motion vector and partition by a factor X which is equal to the number of computational clusters searching their segments of the search region in parallel.

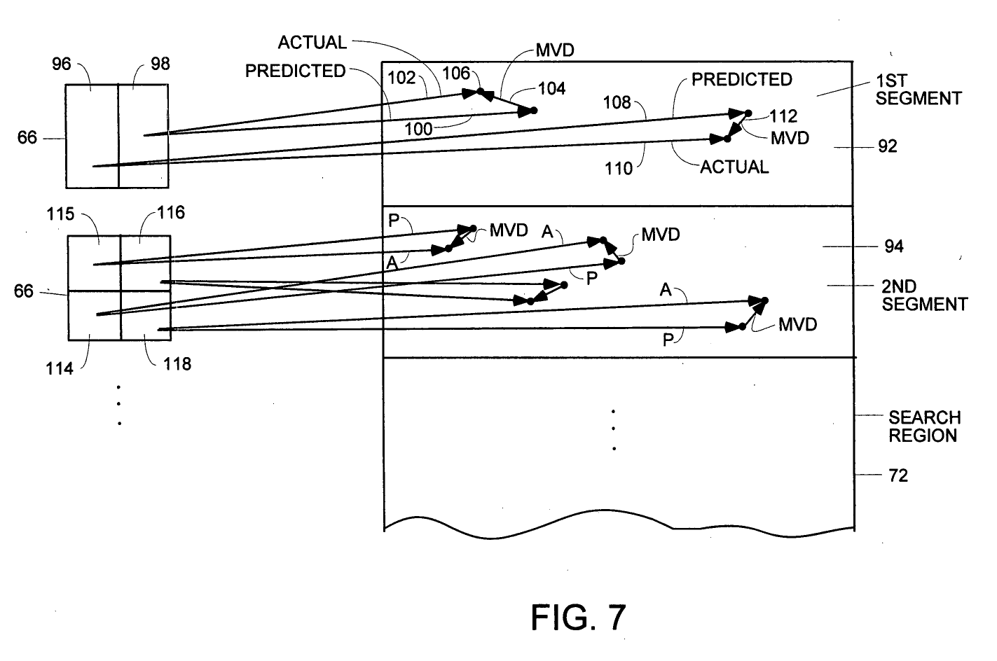

FIG. 7 illustrates an example of what might be computed for a particular macroblock for two searches and computations of Equation (2) carried out simultaneously by two computational clusters in two separate segments 92 and 94 of the search region 72. The first cluster determines that partitioning the macroblock into two 8×16 partitions 96 and 98 is best for purposes of minimizing the value of Equation (2). It also calculates that for partition 98, the predicted motion vector 100 is not right and that the actual motion vector to minimize Equation (2) should be as shown at 102. The MVD or difference vector 104 is then calculated for encoding along with the error image between the pixels in 8×16 array 98 and the 8×16 array of pixels having its origin at 106 in segment 92 of the search region. MVD 104 and the error image just described are not selected yet for encoding because the other MVDs and error images resulting from searches of the other segments may have a lower score for Equation (2). Likewise, for 8×16 partition 96, predicted motion vector 108 is found to differ from the actual motion vector 110 which minimizes Equation (2) by MVD vector 112. Each MVD vector has a number of bits needed to encode it that can be looked up in a table. The number of bits depends upon the length and relative angle of the MVD vector relative to the predicted motion vector and is specified by the H.264 standard. A table lookup is not even needed if the order in which the motion vectors are scanned is known, then the overhead needed to encode the MVD for an actual motion vector terminating at each new trial and error destination point is known.

Computational cluster 2 determines from segment 94 of the search region that two 8×8 sub-block array 114 and 115 in the left half and two 8×8 sub-block arrays 116 and 118 are best to minimize Equation (2). For each of these sub-blocks an actual motion vector marked A is found which differs from the predicted motion vector marked P by a difference vector marked MVD. This process in cluster 2 happens simultaneously with the search and computation process carried out in cluster 1 and simultaneously with search and computation processes carried out in the other search region segments by other computational clusters.

### The Preferred Integer Motion Estimation Algorithm

The Motion Vector Search Region

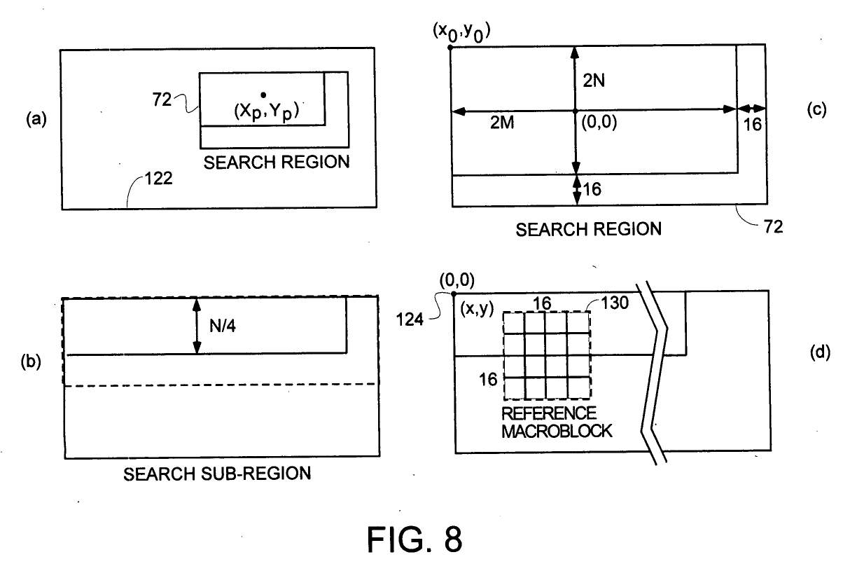

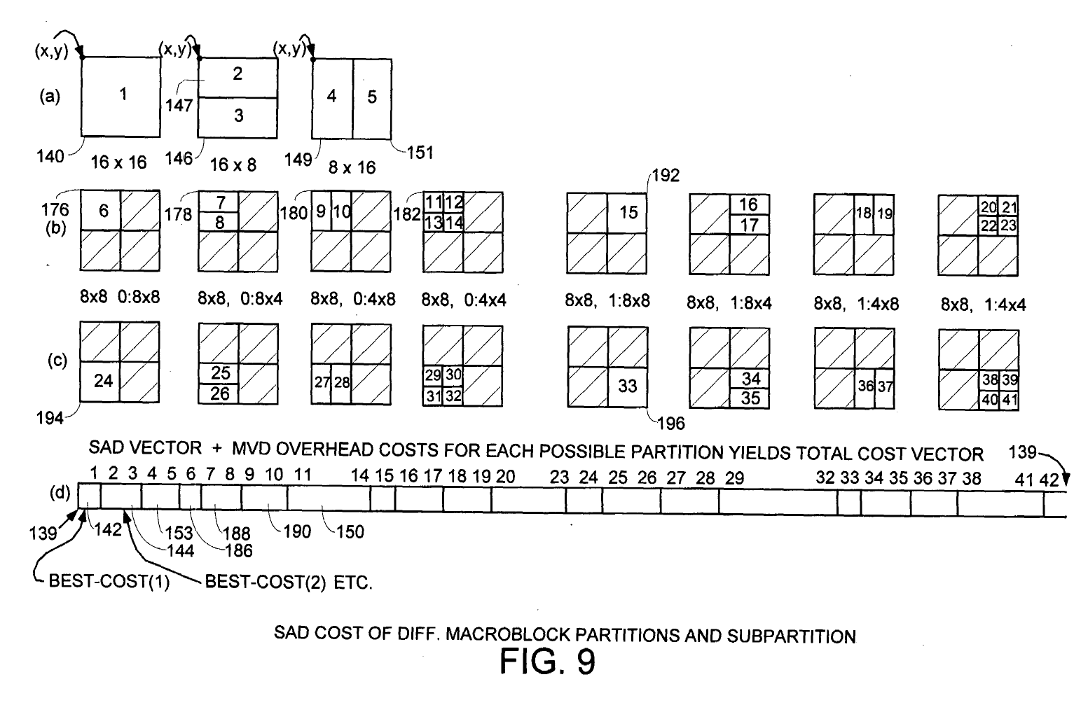

FIG. 8, comprised of FIGS. 8(a) through 8(d), illustrates the concepts employed in selecting a search region from the reference frame with the destination pixel coordinates of the predicted motion vector established in the mid section of the search region. The quest in the integer search of the preferred embodiment is to evaluate the costs for all the possible partitions for a 16×16 tile (also referred to as a macroblock) having its origin at a particular integer location in the reference frame search area and then pick the partition having the best cost. This cost will include the cost of the MVD motion vector difference vector translating the termination point of the estimated motion vector to the pixel in the search area at the origin of the first candidate 16×16 tile.

The process is then repeated for a second 16×16 macroblock in the search area with its origin at the next pixel in the raster scan order which is two pixels over from the pixel of the origin of the 16×16 tile just evaluated. The best partition (best cost) for that macroblock is determined, and a cost vector storing the costs of all the partititions and sub-partitions of the previous (first) 16×16 tile is updated at all positions in the cost vector where a partition or sub-partition of the second macroblock was lower than the cost of the same partition or sub-partition of the first macroblock. This process is repeated for all the tiles having origins in the search area segment at one of the pixels in a grid of pixels in the search area segment which are separated by an integer number of pixels (usually 1 or 2 pixels for the purpose of coarse motion estimation).

This coarse or integer resolution search process goes on simultaneously for each search area segment in each processor of a parallel processing architecture computer having a plurality of processors. Finally, the lowest cost partition or sub-partition for all the search area segments is found by finding the lowest cost partition or sub-partition in each search area segment and then finding the lowest of those. That lowest cost partition or sub-partition will be the 16×16 tile in the search area which is selected to encode the SAD of the 16×16 tile to be encoded, and an MVD from the tip of the estimated motion vector to the origin of this tile will be calculated and the overhead bits to encode this MVD will the overhead bits sent (they are already included in the cost calculated for the winning tile as will be seen from the process described more fully below).

The process is then repeated in a restricted search region at sub-pixel resolution starting from the lowest cost partition found in the previous stage in some embodiments.

Motion vectors are predicted in H.264, so before the motion vectors search begins to to start the minimization process to find the minimum value for Equation (2) for a macroblock to be encoded (hereafter referred to as the subject macroblock), first the subject macroblock's neighboring macroblocks have to have already been encoded. Once the neighboring macroblocks are encoded, their motion vectors are known and a motion vector for the subject macroblock is predicted.

The fact that according to the H.264 specifications the inner partitions of the macroblock require the motion vectors of their left and upper neighbors to form the predicted motion vector impedes the motion estimation for all macroblock partitioning modes simultaneously. We overcome this difficulty by forming an approximate predicted motion vector, which is computed as if the macroblock was encoded using the 16×16 partitioning mode. This prediction is subsequently refined once the best partitioning mode is selected. Together with the approximate encoding cost in Equation (2), this assumption constitutes a reasonable compromise for achieving significantly faster computation.

After the already decoded macroblocks that neighbor the subject macroblock are used to predict the motion vector (xₚ, yₚ) for the subject macroblock (shown as the P vectors in FIG. 7), the search for the correct partition and the motion vector(s) for the macroblock or each sub-block into which it is divided is begun by establishing a search region in which the termination points for the motion vector(s) will be found.

There is a search region hierarchy. FIGS. 7(a) through 7(d) illustrate the various concepts to be discussed next. The search region 72 is in the reference frame (one or more previous frames), and is centered on the termination point (xₚ, yₚ). The motion estimation algorithm will search the search region for the best motion vector(s) for the subject macroblock in the region [xₚ−M, xₚ+M ]×[yₚ−N, yₚ+N ]. Typically, M and N each are set equal to 16 or 32, but they can be set to any number supported under the standard. The H.264 standard limits the, maximum MV size, depending upon the level of the encoded stream to ensure compatibility with the decoder. The search region 72 in the preferred embodiment is set to have size (2M+16)×(2N+16) which includes 16 pixel margins on the right and bottom, and which is centered at ( xₚ, yₚ) in the reference frame is extracted from the reference frame 12 and brought into the group memory. The group memory refers to a shared memory in a parallel processing architecture called the Avior architecture which has four groups of calculation nodes each of which is called a cluster, each group having eight clusters which share a group memory. This is the preferred architecture to perform the parallelized motion estimation algorithm, but any parallel architecture which can perform data independent parts of the process in parallel to speed up the ultimate conclusion will suffice to practice the invention. The Avior architecture is shown in FIG. 4.

The motion vectors are searched relative to (xₚ, yₚ), ranging between [−M, M]* [−N, N], as illustrated in FIG. 8(c). To speed the process up by parallelization, the search region is divided up into eight non-overlapping segments or sub-regions [−M, M]×[k/4−1)N, ((k+¼−1)N−1, k=0, . . . ,7. Basically, one divides the search region up into eight slices and copies the pixels from each slice with overlapping margins of 16 pixels on the right and bottom into one of the computational clusters of the parallel processing system. One sub-region is shown in FIG. 8(b). The motion estimation algorithm (an organized search) is then performed on each slice simultaneously in each of the clusters producing eight best candidates and their encoding cost estimates. Then the best of the candidates (the one with the lowest cost) is selected.

The actual motion vectors terminate at candidate pixels which are at the origin (x, y) of a candidate 16×16 reference tile (130 in FIG. 8(d)). In other words, the current actual motion vector during any particular iteration terminates at a candidate pixel (x, y—which is at the origin of a 16×16 candidate tile) in the search region segment. The coordinates of this point (x, y) are given in relative terms with respect to the origin or upper left corner of the search region, shown at 124 in FIG. 8(d). The origin of the search region is arbitrarily set as coordinate (0,0). It is preferred to translate the (x, y) termination points of the MVD motion vectors which define the difference in spatial terms between the actual motion vector termination point and the termination point of the predicted motion vector. To do this, it is necessary to translate coordinate (x, y) for the MVD termination pixel to the system of the coordinates with the origin at (0,0). The MVD goes from xₚ, yₚ—which is the tip or termination point of the estimated motion vector) to (x, y). To make this translation, an offset vector (x₀, y₀)=(−M, (k/4−1)N) has to be added to (x,y) where (x,y) is any one of the candidate termination points for the candidate MVD motion vectors tried in the search sub-region.

In sub-region 90 of FIG. 5, each one of the candidate pixel points 126 and 128, etc. is a possible termination point (x,y) for a candidate MVD which describes an actual motion vector to replace the predicted motion vector 68 and its termination point 70. The pixel points illustrated in FIG. 5 are separated by two pixels in all directions for the coarse search phase. Each of the candidate pixel points 126, 128, etc. has its overhead bits for MVDₓ and MVD_{y} precalculated and stored so these overhead values can be prefetched and stored in the computational cluster to save the time of a table lookup.

### Integer Resolution Motion Estimation

The purpose of the integer resolution motion estimation is to select the best macroblock partition and, possibly, a sub-partition, and provide a rough estimate of the best motion vectors found in the search sub-region with integer pixel resolution. For that purpose, 16×16 reference tiles 130 of pixels from the search region are used, each with an origin at a candidate pixel having coordinates x, y (where x and y are incremented on a two pixel skip for each new candidate). These reference tiles are extracted from the search sub-region in raster scan order during the search for the lowest cost. One such 16×16 candidate reference tile (a candidate reference tile is a tile whose origin is pointed to by a candidate motion vector) is shown at 130 in FIG. 8(d). The idea is to calculate the value for Equation (2) for tile 130 with the candidate motion vector terminating at (x, y).

FIG. 12 is a diagram which illustrates the SAD calculation process using 4×4 pixel arrays from the 16×16 pixel reference tile 130 and the original 16×6 pixel macroblock array 200 to be encoded. A 16×16 pixel reference tile 130 having its origin at candidate actual motion vector termination pixel (x, y) is selected. This 16×16 reference tile 130 is divided into sixteen non-overlapping 4×4 pixel blocks (as is every other 16×16 reference tile selected on subsequent iterations), and is processed to calculate the total SAD value for each 4×4 pixel block in raster scan order. The 16×16 pixel original macroblock 200 from the frame being encoded is stored in the cluster also and is also divided into 4×4 pixel blocks, and is scanned in the same raster scan order. Scanning in this case means first 4×4 block 210 from the reference tile is compared to 4×4 block 212 from the original macroblock 200, and the SAD (sum of the absolute differences between the values of corresponding pixels of the two 4×4 blocks) of these two 4×4 blocks is calculated and stored in block 218 of SAD array 220. Then, the same thing is done for 4×4 block 214 and 216. This process is repeated until all the blocks of SAD array 220 have been filled with the SAD values of the 16 corresponding pairs of 4×4 blocks from the reference tile 130 and the original tile 200.

The preferred Avior parallel computing architecture is optimized to do 4×4 array integer arithmetic and can calculate all 16 SAD values in less than 48 clock cycles.

As illustrated in FIG. 12, for each of the 4×4 blocks, the sum of the absolute differences in pixel values (SAD) between the reference block and the original block being encoded is computed. The results are stored in a 4×4 matrix containing the SADs of all 16 blocks in their scan order, namely:

$$SAD ( i , j ) = {\sum }_{m = 4 ( j - 1 )}^{4 j - 1} {\sum }_{n = 4 ( i - 1 )}^{4 i - 1} \vert REF ( x + m , y + n ) - ORIG ( m , n ) \vert \qquad ( 3 )$$

### The elements of SAD are indexed in column-dominated order.

FIG. 9, comprised of FIGS. 9(a), 9(b), 9(c) and 9(d), shows all the different possible macroblock partitions and sub-partitions. The idea is to find the partition or sub-partitions with the lowest cost, i.e., the smallest amount of differences from the tile being encoded. Since the MVD always points to the macroblock origin, the overhead cost for using the MVD for a specific tile is the same regardless of the particular location of the tile within the macroblock. Therefore, the same overhead cost is added to each element of the cost vector 139, and that overhead cost depends upon which of the pixels 126, 128 etc. in FIG. 5 is at the origin of the reference macroblock. These overhead costs are pre-computed. In the case of the two 16×8 sub-partitions 146 and 147 in FIG. 9(a), whose SAD costs are recorded in elements 2 and 3, the overhead cost of an MVD to origin (x, y), the overhead of this MVD is added once to element 2 and once to element 3. The same situation applies to any of the other multiple sub-partitions possibilities shown in FIGS. 9(a), 9(b) and 9(c).

The elements of the SAD matrix are summed according to all possible partititions and sub-partititions of the macroblock, as shown in FIG. 9 comprised of FIGS. 9(a), 9(b), 9(c) and 9(d). The results are stored in a 41×1 cost vector shown in FIG. 9(d) at 139 (represented as three 16×1 vectors, with seven elements of the last vector left unused). For example, the first element of the vector, shown at 142, contains:

$${s}_{1} = {\sum }_{i = 1}^{4} {\sum }_{j = 1}^{4} SAD ( i , j ) \qquad ( 4 )$$

which corresponds to the SAD cost of the 16×16 partition shown at 140 in FIG. 9(a). In Equation (4) indices i and j identify the particular SAD value blocks in the SAD array 220 of FIG. 12. So equation (4) means all 16 SAD values in the 16 blocks of SAD array 220 are summed, and that is the SAD value for partition 140 in FIG. 9(a) (the partition with no sub-partitions). That single SAD value plus the MVD overhead is stored in element 1 shown at 142 of the cost vector 139 in FIG. 9(d).

Since the cost is additive, the cost of a specific partition can be computed as the sum of the costs of the 4×4 tiles of which it consists. In this way, we do not compute the computationally expensive SAD for overlapping partitions; we rather perform a significantly cheaper scalar addition operation to sum the elements of the SAD matrix. This can be done very efficiently using the Avior architecture or any other architecture which is optimized for 4×4 matrix integer math to break each 16×16 array into sixteen 4×4 blocks. Any parallel processing architecture computer or gate array or ASIC which is programmed or “hardwired” (netlist structures device to perform any process within the genus) to perform any process within the genus of processes described herein will suffice to practice the invention Likewise, the second and third elements (shown at 144 in FIG. 9(d)) of the cost vector 139, corresponding to sub-partitions 146 and 147 of FIG. 9(a), contain SAD values as follows:

$$\begin{matrix}{s}_{2} = {\sum }_{i = 1}^{2} {\sum }_{j = 1}^{4} SAD ( i , j ) and & ( 5 ) \\ {s}_{3} = {\sum }_{i = 3}^{4} {\sum }_{j = 1}^{4} SAD ( i , j ) & ( 6 )\end{matrix}$$

corresponding to the SAD cost of the upper and the lower parts of the 16×8 sub-partitions marked 2 and 3 in FIG. 9(a).

Each of formulas (4) through (6) calculates the sum of the absolute differences in pixel values of the pixels in the different partitions of the reference macroblock and the actual macroblock for a reference macroblock whose origin is pointed to by the current candidate motion vector. The current candidate motion vector points to the 16×16 macroblock in the reference frame having its origin at (x,y) as shown in FIG. 8(d). Equation (4) above calculates the SAD cost for the 16×16 partition 1 shown at 140 in FIG. 9(a) and stores the result in cost vector 139 at position 1, indicated at 142 in FIG. 9(d). Equation (5) above calculates the cost of the 16×8 partition 2 shown at 147 and puts that cost in the second position of motion vector 139. Likewise, Equation (6) calculates the SAD cost of the 16×8 partition 3 at 146 in FIG. 9(a) and places that at position 3 of cost vector 139.

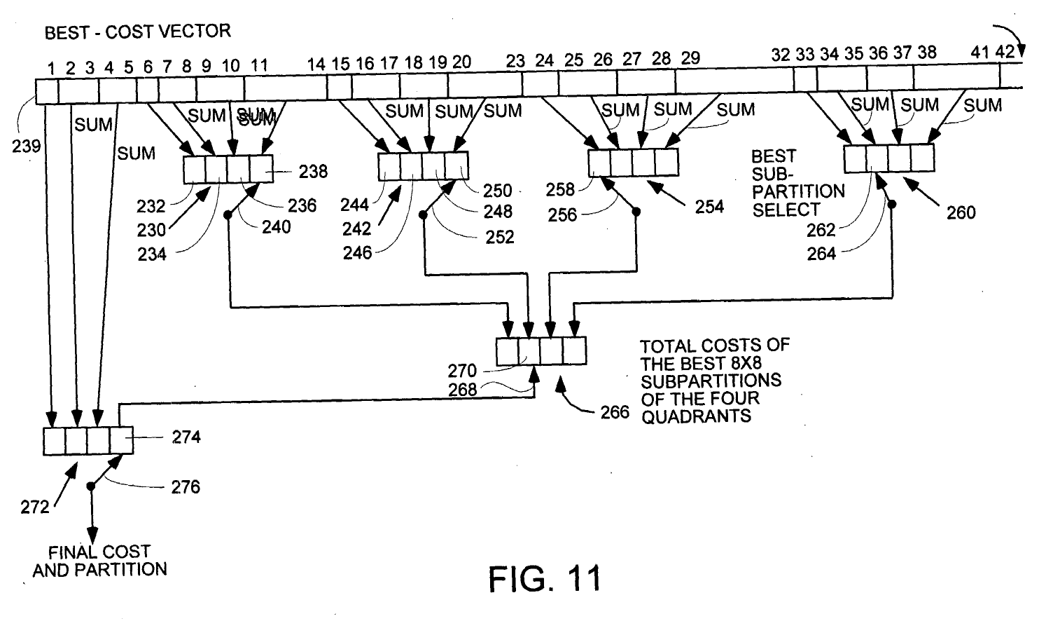

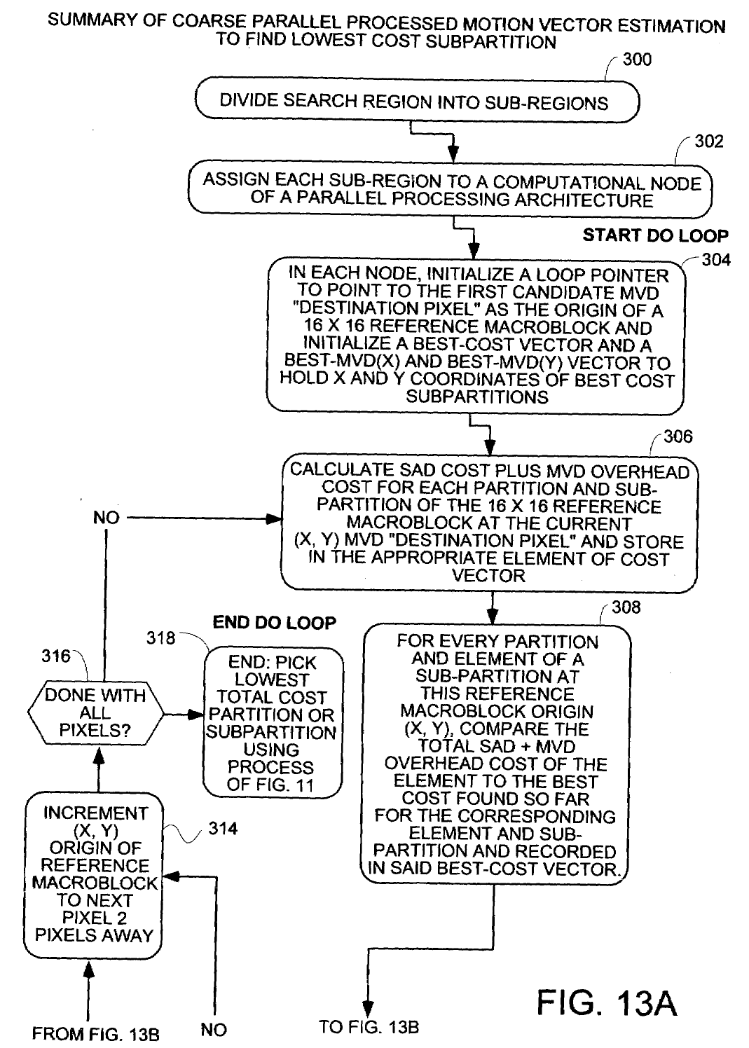

This process is repeated for each possible sub-partitition option shown in FIGS. 9(b) and 9(c) to fill in all the cost elements of cost vector 139. As mentioned above, the computational complexity of the described process is significantly lower than that of direct cost computation of all the possible partitions and sub-partitions. When the cost vector elements have been completely populated with SAD plus overhead costs for the various sub-partitions for the first time, some of its elements are stored as the best-cost vector and will be used as the lowest cost reference to be updated as new partitions at new candidate MVD termination pixel positions are calculated and return lower costs. This updating process will be explained in detail in a subsequent patent application and this updating or fine tuning process does not form part of the claimed invention in this patent application. The next candidate motion vector terminating at a new pixel (x, y) in the search area sub-segment is then tried for the next iteration and a new 16×16 reference macroblock having its origin at the new (x, y) is imported into the memory of the computation cluster which is searching for the best cost partition in the sub-segment of the search area. This process is going on simultaneously in all sub-segments of the search region, but in different computational clusters. Each new iteration produces a new cost vector 139. Each element of each new cost vector is compared to the corresponding element of the best-cost vector, and if it is smaller, the element from the cost vector 139 is substituted into the best-cost vector to update it. Then the best cost partitioning mode can be found by computing the total partition cost out of the vector elements, as symbolized by FIG. 11. In other words, FIG. 11 is a diagram which symbolically illustrates the process of picking the lowest cost macroblock partitioning mode from the best-cost vector.

The idea is to calculate all the SAD costs for the various partitions shown in FIGS. 9(a), 9(b) and 9(c) for the current destination pixel for the candidate actual motion vector (terminating at candidate pixel (x, y) in FIG. 8(d), and then repeat the process for the next iteration of the actual motion vector (terminating at a different one of the pixels in FIG. 5 than the pixel the candidate actual motion vector pointed to in the earlier iteration). During the coarse estimation search phase, the candidate termination pixels for the actual motion vector candidates are spaced apart by two pixels.

Each candidate actual motion vector has an MVD overhead cost which is fixed for any given candidate motion vector termination pixel in FIG. 5. To account for this overhead, i.e., the term λ* bits(MVD) of Equation (2) above, the cost of each part of the partition is incremented by

overhead=λ(bits(MVDx)+bits(MVDy)) (7)

where bits(x) and bits(y) denote the number of bits required to encode the motion vector difference MVDx and MVDy respectively, and λ is the rate-distortion Lagrange multiplier set by the bit rate controller. The bit coding overhead is known in advance and can be accessed by a table lookup, but in the preferred embodiment, it is pre-fetched and stored in the memory of the computational cluster doing the search to save the time of a table lookup. This overhead cost is added simultaneously to all the elements of the SAD cost vector, resulting in the current total cost vector cost shown at 139 in FIG. 9(d). The first element of the cost vector 139, denoted s₁ and shown at 142, expresses the SAD+MVD cost of the no sub-partition 16×16 macroblock partition when the motion vector terminates at position (x,y) in FIG. 8(d). Likewise, the second and third elements of the cost vector 139, shown at 144, expressed as Equations (5) and (6) above, is summed, and that is the total cost (after MVD overhead is added for two candidate actual motion vectors, each terminating at (x, y) in FIG. 9(a)) if the two 16×8 sub-partitions marked 2 and 3 in FIG. 9(a) were to be used.

This same process is repeated for all the other candidate sub-partitions shown in FIGS. 9(b) and 9(c), with each candidate sub-partition marked with the number of the element in the cost vector where the cost of that candidate sub-partition will be recorded (plus its MVD overhead). For example, the four candidate sub-partitions shown at 182 in FIG. 9(b) and marked 11, 12, 13 and 14 will have their SADs calculated, and to each SAD will be added, respectively, the overhead for the MVD of one of four candidate actual motion vectors for sub-partitions 11, 12, 13 and 14, each terminating at (x,y). The resulting costs for each of the sub-partitions 11, 12, 13 and 14 will be recorded at positions 11 through 14 of the cost vector 139, illustrated generally at 150.

The values of the MVD overhead terms bits(x) and bits(y) are tabulated in tables. Since x and y are incremented sequentially during the search as each new 16×16 macroblock from the reference frame pointed to by the new candidate actual motion vector is tried, the values of the overhead terms bits(x) and bits(y) can be pre-fetched from the table and stored in the cluster memory in the order in which they will be needed (the order in which new candidate actual motion vectors are tried). This avoids the need for a time-consuming and therefore costly table lookup operation.

The coarse search algorithm holds three 1×41 vectors: a best-cost vector(the best partial cost for each partition or sub-partition found so far) each initialized by 65535, and best-MVDₓ and best-MVD_{y}vectors holding the actual motion vector differences (the differences between x and y and the termination pixel coordinates xₚ, yₚ of the predicted motion vector) corresponding to the lowest cost partition or sub-partition found so far.

For every new candidate motion vector terminating at a new (x, y), the cost vector 139 is computed and is compared on and element-by-element basis to the best-cost vector. As the result, a 1×41 mask vector is created, in which the bit or bits corresponding to the candidate partition where cost<best-cost are set to one, and the bits corresponding to cost≧best-cost are set to zero. In other words, the 1s in the mask mark the locations in the cost vector 139 where the calculated SAD and MVD overhead cost are less than the previously found best cost for some other partition or sub-partition. The best-cost vector is then updated to the best cost found so far by updating the best-cost vector by combining cost and best-cost using this mask.

best-cost=(cost AND mask) OR (best-cost AND NOT mask) (8)

In other words, the best-cost vector is created by substituting into the cost vector 139 in FIG. 9(d) the lowest cost partitions at the appropriate positions of the cost vector. In this way, the value of best-cost can only decrease if a new candidate partition has a lower cost or stay the same if the new candidate partition has a higher cost than a partition whose cost was previously calculated and is the current lowest cost.

In the same way, the best motion vectors are updated:

best-MVD=(MVD AND mask) OR (best-MVD AND NOT mask) (9)

where MVD is a 1×41 vector of replicated values of x or y.

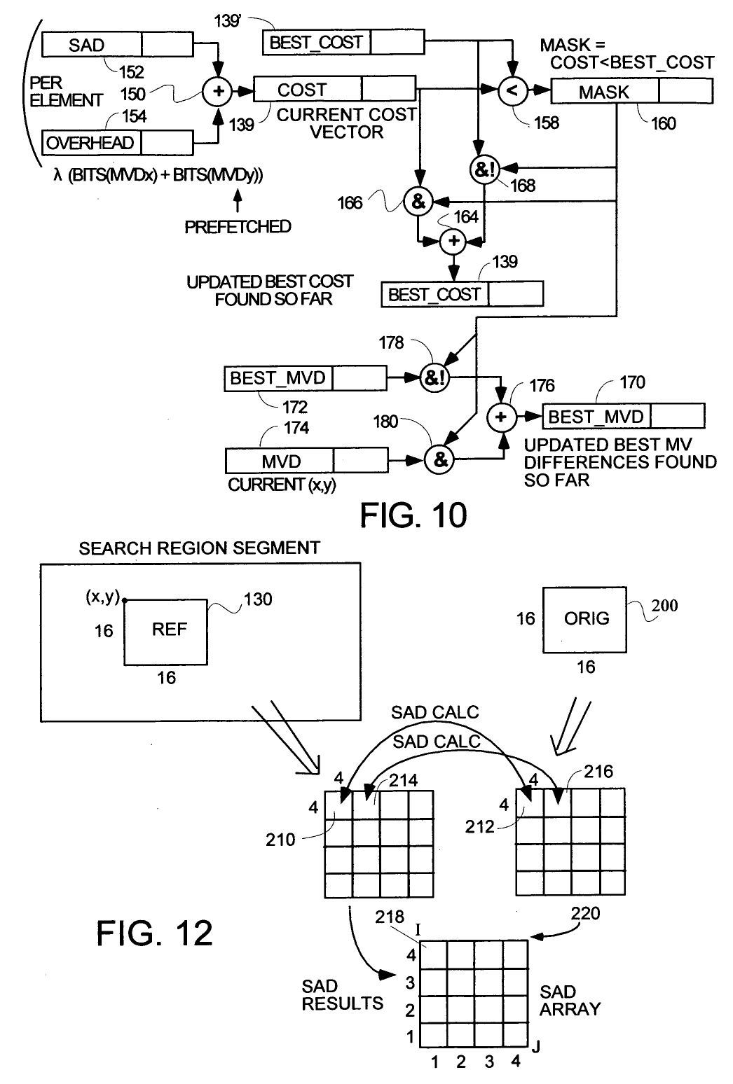

The update procedure is depicted in greater detail in FIG. 10. Adder 150 represents the process step of summing the calculated 41 partial SAD cost values 152 on an element-by-element basis. To this sum is added the overhead bits 154 needed to transmit the MVD. The SAD values are the SAD calculated for all macroblock partitions and sub-partitions for the candidate MVD (x, y). The pre-fetched MVD overhead are the bits to express the MVD x and y coordinates at the MVD's termination point (the termination point (x, y) of the actual candidate motion vector currently being evaluated). The MVD has its origin at the termination point of the estimated motion vector. The result is the partial cost 139 for the macroblock of sub-partition thereof being evaluated.

The “less than” operator 158 represents the process of comparing the cost 139 of the partition under evaluation to the best-cost vector 139′ (the cost vector 139 after updating with the best costs found so far previously found for other partitions) to set or clear the bits of mask 162. If cost recorded in an element of cost vector 139 for the candidate partition is less than the corresponding element in the best-cost vector 139′, then the mask bit in the mask vector 160 for the 1×41 vector elements representing the candidate partition is set to one. This comparison and bit setting process happens for every element of the cost vector 139.

The mask vector 160 is then used to guide combination of the best-cost vector 139′ and the cost vector 139 into an updated best-cost vector 139′, as symbolized by summer 164 and gating operators 166 and 168 which receive guidance from the mask vector 160 to act as gates in deciding whether the contents of the element of cost vector 139 or the corresponding element of the best-cost vector 139′ get substituted into the best-cost vector 139′. This substitution or filling process goes on an element-by-element basis of the best-cost vector 139′ until all elements have been updated or left alone. SIMD architectures like the Avior are capable of performing such element-by-element operations very efficiently.

A similar process is followed to create the best MVD vector 170 from the current MVD vector 174 (representing the cost to express the current candidate MVD termination point (x, y)) and the vector 172 representing the least cost MVD found so far. Summer 176 fills vector 170 using gating operators 178 and 180 under the control of the mask vector 160.

### Best Macroblock Partition Selection

FIG. 11 is a diagram which symbolically illustrates the process of picking the lowest cost macroblock sub-partition for each of the four quadrants of a 16×16 reference tile from the best-cost vector. After all candidate motion vectors in the search sub-region are processed, the best-cost vector will contain the lowest cost element found for each partition and sub-partition possibility of each quadrant of the 16×16 reference tile. To pick the best sub-partition for each quadrant, the total cost of each element is calculated for sub-partitions comprised of several elements. Note that the best-cost vector 239 in FIG. 11 is paired with best-MVDₓ and best-MVD_{y} vectors so each lowest cost element in the best-cost vector may be with reference to a different MVD. Thus for example, the lowest cost partition of the upper right quadrant may be comprised of elements 11, 12, 13 and 14 from four different 16×16 tiles, each having their own motion vector. That is the import of the teachings of FIG. 10. Thus, to encode the upper right quadrant of the original 16×16 macroblock using the lowest cost elements 11, 12, 13 and 14 may require four different MVDs.

The computation of the total cost of the macroblock sub-partition consists of summing the partial costs costs of all of its elements. FIG. 11 schematically illustrates this process of computing the total cost of each macroblock partition candidate's elements from the best-cost vector and picking the lowest cost one. For example, the total cost of the 16×16 partition 140 in FIG. 8(a) consisting of a single part is simply best-cost(1), meaning the entry in the first location 141 in FIG. 8(d) of the best-cost vector 139.

Likewise, the total cost of the two 16×8 partitions 146 and 147 in FIG. 8(a) is the sum of best-cost(2)+best-cost(3) shown at 144 in FIG. 8(d). The total cost of the two 8×16 partitions 149 and 151 is best-cost(4)+best-cost(5) shown at 153 in FIG. 8(d).

In order to find the lowest cost 8×8 partition (quadrant) and the corresponding total cost, we first calculate the total costs of each of the four sub-partitions of the four 8×8 blocks. In other words, for the 8×8 partition representing the upper left quadrant (176 in FIG. 9(b)), there are four possible sub-partitions: 8×8 shown at 176 (best-cost vector element 6); two 8×4 sub-partitions shown at 178 (best-cost vector elements 7 and 8); two 4×8 sub-partitions shown at 180 (best-cost vector elements 9 and 10); and four 4×4 sub-partitions shown at 182 (best-cost vector-elements 11, 12, 13 and 14). The cost of the sub-partition 176 is recorded at best-cost(6). The cost of the sub-partition 178 is best-cost(7)+best-cost(8). The cost of sub-partition 180 is best-cost(9)+best-cost(10). The cost of sub-partition 182 is best-cost(11)+best-cost(12)+best-cost(13)+best-cost(14). These four costs are recorded in best-cost vector 139 at 186, 188, 190 and 150, respectively.

The sub-partition having the lowest cost for the upper left quadrant shown at 176 can then be selected. In FIG. 11, this is symbolized by placing each of the four costs for the sub-partition options shown at 176, 178, 180 and 182 for the upper left quadrant into one of the elements of a 4×1 vector 230. The cost of 8×8 sub-partition 6 shown at 176 is stored in element 232 of vector 230. The cost of the two 8×4 sub-partitions 7 and 8 are summed and stored in element 234. The cost of the two 4×8 sub-partitions 9 and 10 are summed and stored in element 236. The cost of the four 4×4 sub-partitions 11, 12, 13 and 14 are summed and stored in element 238. The lowest total cost sub-partition for the upper left quadrant is then selected, as symbolized by selector switch 240 selecting the cost element 238 as the lowest cost.

This process of finding the lowest cost sub-partition of each of the upper left quadrant 176, upper right quadrant 192, lower left quadrant 194 and lower right quadrant 196 is performed simultaneously for each of the four 8×8 blocks or quadrants. This can be done in one processor using 4×4 matrix operations, and this is the preferred embodiment since the other clusters are busy doing the search and select process in their own sub-regions. In other embodiments, the creation of the 4×1 vectors storing the total costs of the four possible sub-partitions of each quadrant and selection of the lowest cost can be done in parallel in multiple processing units in some embodiments. For example, while one cluster is storing the cost for partition 6 in element 232 and summing the cost elements of the other sub-partitions, and storing them in vector 230 and picking the lowest cost element, another cluster is doing the same sort of thing for a 4×1 vector 242 for the upper right quadrant. In that cluster, the cost of the 8×8 sub-partition 15 for the upper right quadrant 192 will be stored in element 244, and the costs of the two 8×4 sub-partitions 16 and 17 will be summed and stored in element. Likewise, the costs of sub-partitions 18 and 19 will be summed and stored in element 248, and the costs of 4×4 sub-partitions 20, 21, 22 and 23 will be summed and stored in element 250. The lowest cost element will then be selected, as symbolized by switch element 252 selecting the cost element 250 as the lowest cost.

Likewise, in such an embodiment, another computational cluster will do this same process for the lower left quadrant 194 and store the four different sub-partition costs in the elements of 4×1 vector 254. In this quadrant 194, the lowest cost sub-partition option is the 8×8 sub-partition 24 stored in element 258 and selected by switch 256.

For the lower right quadrant 196, the costs of the sub-partition options are stored in 4×1 vector 260 and the lowest cost sub-partition option is the sum of elements 34 and 35 stored in element 262 and selected by switch 264.

The switches in FIG. 11 are metaphors only for a software process which creates the 4×1 vectors, populates them with the total costs of the four possible sub-partitions of each quadrant and then scans the four total costs of the four sub-partition options for the quadrant and picks the lowest cost from each of 4×1 vectors and stores it in one of the elements of another 4×1 vector 266. These lowest total costs for the sub-partitions of each quadrant are then summed, and the sum is stored in element 274 of a another 4×1 vector 272. The first three elements of vector 272 store the total costs of the sub-partition 1 (140 in FIG. 9(a)), sub-partition 2 plus sub-partition 3 (shown at 146 and 147 of FIG. 9(a), and sub-partition 4 plus sub-partition 5 (shown at 149 and 151 of FIG. 9(a)). Basically, vector 272 allows comparison of the cost of the three different sub-partitions shown in FIG. 9(a) to the lowest total cost for the lowest cost sub-partitions of the four quadrants.

Switch 276 symbolizes the selection of the final lowest cost for the overall 16×16 original macroblock 200 in FIG. 12, and the partition or sub-partitions that produced it. The result of the process symbolized by FIG. 11 is the lowest cost partition or sub-partition of the 16×16 reference macroblock found after considering every candidate origin pixel and every one of the possible partitions and sub-partitions shown in FIGS. 9(a), 9(b) and 9(c). The resulting best cost vector 239 of FIG. 11 has a separate MVD motion vector for each of the elements of any of the sub partition. In other words, since the best-cost vector records the lowest total cost for each element of each sub-partition, the final cost and partition output by switch 276 could be comprised of elements from different reference macroblocks within the search region. For example, referring to FIGS. 9, 11 and 5, the lowest cost sub-partition was comprised of elements 20, 21, 22 and 23 shown in FIG. 9(b) for the upper right quadrant. Each of elements 20, 21, 22 and 23 in the best-cost vector was the lowest cost one of that particular element found after considering that particular sub-partition at each of the candidate pixels illustrated in FIG. 5 for the search sub-region 90. Thus, element 20 could have come from the reference macroblock with its origin at pixel 126, element 21 could have come from the reference macroblock with its origin at pixel 128, element 22 could have come from the reference macroblock with its origin at pixel 325 and element 23 could have come from the reference macroblock with its origin at pixel 327. Thus, this lowest cost sub-partition would have recorded for it four different MVD motion vectors pointing at pixels 126, 128, 325 and 327.

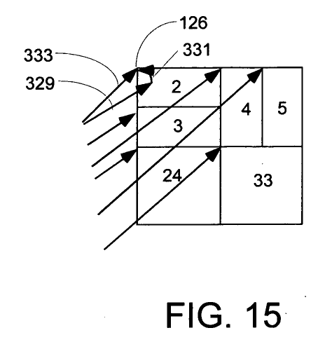

An example of what can result from the coarse search is illustrated in FIG. 15. FIG. 15 shows a lowest cost partition and sub-partition selection where each of the lowest cost elements of a sub-partition has a different MVD motion vector. The sub-partition type illustrated at 178 in FIG. 9(b) turned out to be the lowest total cost for the upper left quadrant, but its component elements 2 and 3 each came from 16×16 reference macroblocks having different origins. The origin for element 2 is at pixel 126 which is recorded in the best-MVDₓ and best-MVD_{y} vectors by and MVD 331 which, when vector added to the estimated motion vector 329 results in a resultant final motion vector 333 which points to origin pixel 126. Similarly, all the other lowest cost elements come from different reference macroblocks and have their origins pointed to by the resultant motion vectors shown.

The software that performs the process of FIG. 11 for each macroblock and each reference block in the search segment keeps track of which sub-partition option produced which costs by the best-MVDₓ and best-MVD_{y} vectors.

The search for the lowest cost sub-partition in each of the four quadrants is data independent (the data in each quadrant is not dependent upon the data in any of the other quadrants). Therefore, the search for the lowest cost sub-partition can proceed independently for each of the four quadrants in four separate computational clusters in some embodiments.

### Summary of Parallel Motion Estimation Process Integer Resolution Search

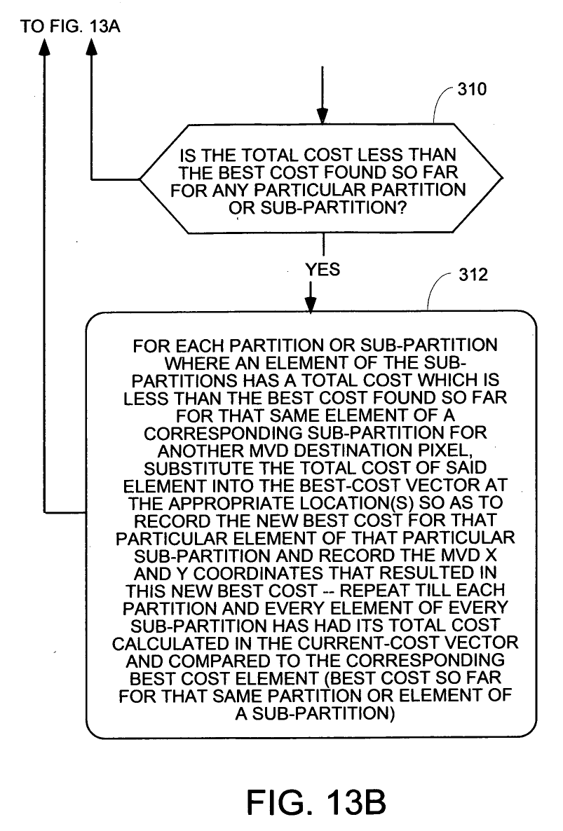

Referring to FIGS. 13(a) and 13(b) which comprise a flowchart of the parallel processing version of the coarse motion estimation process to find the lowest cost partition or sub-partition of the reference macroblock to encode the macroblock to be encoded. Step 300 represents the process of dividing the search region 122 in FIG. 8 up into multiple search sub-regions, preferably the same number of sub-regions as there are computation nodes in the parallel processing architecture to be used to carry out the calculations described. In step 302, each sub-region is assigned to a computational node. Step 304 represents the beginning of a do loop which is performed in each computational node in parallel on different reference macroblocks within their sub-regions. In step 304, a loop pointer is initialized to point to the first of a number of candidate pixels for the MVDs in the coarse search mode. These pixels are separated by two pixels, and pixels 126 and 128 in FIG. 5 are examples of these pixels for the first search sub-region. A 1×41 best-cost vector is then initialized to some high value which will be higher than any partition or sub-partition cost. Likewise, 1×41 MVDₓ and MVD_{y} vectors are also initialized. When the search process is complete, the best-cost vector will contain the best total SAD plus overhead costs for each partition and sub-partition possibility of all the possibilities illustrated in FIGS. 9(a), 9(b) and 9(c), and the MVDₓ and MVD_{y} vectors will contain the x and y coordinates of the MVDs pointing to the origins of the reference macroblocks which contained each partitition or sub-partition which is stored as the best cost in particular positions of the best-cost vector. For every element or elements of the best-cost vector which record the costs of a particular partition or sub-partition, there are corresponding elements in the MVDₓ and MVD_{y} vectors will contain the x and y coordinates of the MVDs pointing to the origins of the reference macroblocks which contained each partitition or sub-partition having the lowest cost.

Step 306 represents the step of calculating the SAD cost plus the MVD overhead cost for each partition and sub-partition possibility shown in FIGS. 9(a), 9(b) and 9(c), and recording these costs in a cost vector 139 shown in FIG. 9(d). This is done as previously described.

Step 308 represents the process of comparing the total cost (SAD+MVD overhead) of each partition and sub-partition possibility to the best cost found so far for that same partition or sub-partition, as recorded in the best-cost vector. In other words, after the cost vector 139 has had all its elements calculated, the SAD cost plus the MVD overhead cost for each element of a partition or sub-partition are totaled and the total cost of each partition or sub-partition element is compared to the best cost found so far for the corresponding partition or sub-partition element, as recorded in the best-cost vector. For purposes of understanding the terminology, an “element” of a sub-partition means one of the component blocks of pixels that go into the makeup of a full 16×16 tile from the search region. For example, the 16×8 sub-partition shown in FIG. 9(a) has two elements labeled 2 and 3 shown at 147 and 146, respectively. Likewise, the 8×8 sub-partition with an origin at 182 has four elements called 11, 12, 13 and 14.

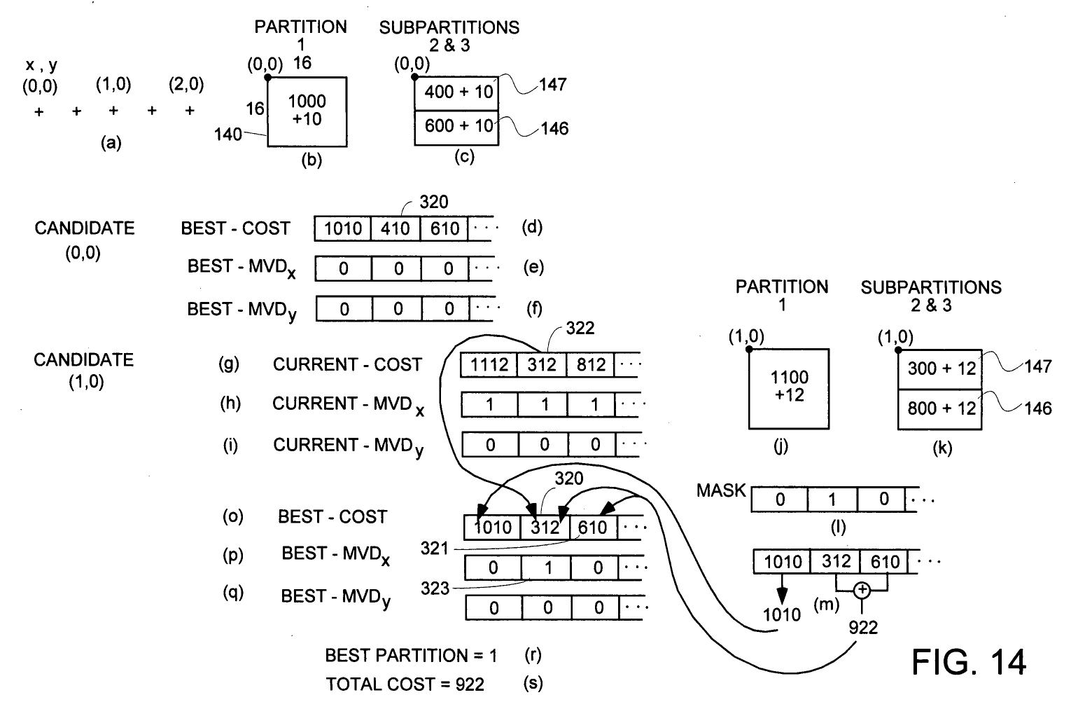

If the total cost of an element of a sub-partition in the cost vector 139 is found to be lower than the best cost found so far for that same element of the same sub-partition (step 310), then that total cost from the cost vector 139 is substituted into the corresponding position of the best-cost vector. This is best understood by reference to FIG. 14 and its description below. Specifically, at origin (0,0), sub-partitions 2 and 3 shown at 146 and 147 of FIG. 14(c) are what will be referred to herein as elements of this sub-partition. Each of these elements has a total cost comprised of an SAD cost and an MVD overhead cost. In the case of origin (0,0), the total cost of element 147 is 410 and the total cost for element 146 is 610. However, at origin (1,0), the total cost of element 147 is 312 and the total cost of element 146 is 812 as shown at FIG. 14(k). Since 312 is less than 410, 312 gets substituted into element 320 of the best-cost vector shown at FIG. 14(o) in the state it has after completion of the calculations of cost for all the various partition and sub-partition possibilities at origin (1,0). Since the cost (812) of element 146 at (1,0) is more than the cost (610) of element 146 at (0,0), no substitution is made into the best-cost vector at the element 321 corresponding to sub-partition 3 shown at 146.

If a lower cost is found and a substitution is made, the x and y coordinates of the destination pixel (origin of the reference macroblock containing the lower cost partition) pointed to by the MVD vector is recorded in the best-MVDₓ and best-MVD_{y} vectors at the elements corresponding to the partition or sub-partition just substituted. In the example just given, the x coordinate of the element 147 (sub-partition 2) at origin (1,0) is 1 so since this is the lowest cost for this sub-partition element up to this point, 1 will be substituted into element 323 of the best-MVDₓ vector shown at FIG. 14(p) and the best-MVD_{y} vector shown in FIG. 14(q) is left alone. Compare these best-MVDₓ and best-MVD_{y} vectors in FIGS. 14(p) and 14(q) to the state these vectors were in (as shown in FIGS. 14(e) and 14(f)) before the (1,0) reference macroblock was processed.

If step 310 found that no cost in cost vector 139 was lower than the best cost found so far for that same partition or sub-partition, step 314 is performed to increment the x and y coordinates of the origin of the reference macroblock to the next pixel (two pixels away) in the sub-region in step 314, and then step 316 is performed to determine if the last pixel in the sub-region has had the reference macroblock with its origin there processed. If so, processing proceeds to step 318 where the lowest cost partition or sub-partition is selected using the process symbolized by FIG. 11. If not all the pixels have been processed yet, processing proceeds to step 306 and the process is started over again at the new (x, y) origin reference macroblock.

FIG. 14, comprised of FIGS. 14(a) through 14(s), is a diagram illustrating how the process of calculating SAD and overhead costs for various partition and sub-partition combinations works and how the mask vector is generated and the best-cost vector is updated using the mask vector. FIG. 14(a) illustrates three candidate “destination pixels” for candidate MVDs which will be origins in the search area for 16×16 macroblock candidates. The first candidate 16×16 pixel array having its origin at (0,0) is shown in FIG. 14(b). This partition corresponds to partition 1 shown at 140 in FIG. 9(a). Its SAD cost is calculated at 1000 plus overhead of 10 for the MVD. Partitions 2 and 3 at origin (0,0) in FIG. 9(a) are shown at FIG. 14(c) and have SAD costs of 400 and 600, respectively, and each has an overhead of 10. Since candidate pixel (0,0) is the first candidate, the best-cost vector will just be set to the costs of these partitions 1, 2, 3 (and all the other sub-partition combinations shown in FIGS. 9(a) through 9(c) because the best-cost vector was previously initialized in step 304 to a very high value. The best-cost vector set to the costs of partitions 1, 2 and 3 is shown in FIG. 14(d). Since the best cost partitions found so far are all in the (0,0) 16×16 array, the elements of the MVDₓ and MVD_{y} vectors corresponding to the x and y coordinates of partitions 1, 2 and 3 are all set to 0, as shown at FIGS. 14(e) and 14(f).

Now, assuming all the possible sub-partitions costs have been calculated for the (0,0) pixel candidate, the process starts again for the (1,0) pixel in FIG. 14(a). The (1,0) 16×16 array's partition 1 SAD cost is 1100 plus an overhead of 12 as shown at FIG. 14(j). The SAD+overhead costs of sub-partitions 2 and 3 are shown at FIG. 14(k). These total costs are entered into a current-cost vector shown at FIG. 14(g) whose elements store the total SAD plus overhead costs of all the partition and sub-partition combinations at origin (1,0). The current MVDₓ and MVD_{y} vectors have their elements set as shown in FIGS. 14(h) and (i) with the x coordinates all set to 1 and the y coordinates all set to 0.

Now the updating process of step 312 begins to update the elements of the best-cost vector to the lowest costs found so far. A comparison is made on an element-by-element basis between the current-cost vector of FIG. 14(g) and the best-cost vector of FIG. 14(d), and the mask vector of FIG. 14(l) is formed. At each element where the current-cost is lower than the best-cost, a logic 1 is set. All elements are set to logic 0. The elements in the current-cost vector which are lower than the corresponding elements in the best-cost vector are substituted into the best-cost vector, and the MVDₓ and MVD_{y} vectors are updated with the x and y coordinates of the origin of the current 16×16 tile at locations corresponding to the sub-partition with the lower cost. In the example of FIG. 14, the total cost 312 of sub-partition 2 shown at 147 in FIG. 14(k) is lower than the total cost recorded in element 320 of the best-cost vector and the mask element corresponding to this element is 1 and all other mask elements are set to 0. Therefore, 312 total cost from element 322 of the current-cost vector of FIG. 14(g) is substituted into element 320 of the new best-cost vector shown at FIG. 14(o), and the best-MVDₓ and MVD_{y} vectors shown at FIG. 14(p) and 14(q) are updated to the state shown there from the state shown in FIGS. 14(e) and 14(f). This update shows that the origin is(1,0) of the 16×16 macroblock in the search sub-region from which the total cost in element 320 came from. If sub-partition 2 at 147 in FIG. 14(k) from the (1,0) tile and sub-partition 3 at 146 in FIG. 14(c) were the lowest cost of all the sub-partitions for all candidate tiles in the complete set of sub-regions after all candidate MVDs had been searched, then encoding of the original 16×16 macroblock 200 in FIG. 12 would be using sub-partitions 2 and 3 with MVDs pointing to (0,0) and (1,0), respectively.

Although the invention has been described in terms of the preferred and alternative embodiments disclosed herein, those skilled in the art will appreciate other alternative embodiments which are within the genus of the invention defined in the summary and which are not specifically detailed herein but which share common characteristics that define the genus which will be apparent to those skilled in the art. All such embodiments are intended to be included within the scope of the claims appended hereto.

What is claimed:

1. A motion estimation process comprising:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original macroblock and a reference macroblock whose origin is pointed by the motion vector into non-overlapping tiles, and computing a matrix of differential costs between the said tiles of the original macroblock and the corresponding tiles of the reference macroblock;
C) for each computed differential cost matrix, computing a partial cost vector whose elements are the partial differential costs of all the macroblock partitions and sub-partitions;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y-components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the macroblock partitioning and sub-partitioning modes;
G) in each computation unit, selecting the macroblock partitioning or sub-partitioning mode and the corresponding MVDs that yield the lowest total cost;
H) among the macroblock partitioning or sub-partitioning modes selected in step G by all computational units, selecting the macroblock partitioning or sub-partitioning mode and the corresponding MVDs that yield the lowest total cost.

2. A process as claimed in claim 1, Wherein the tile size is set to be the maximum size contained in all macroblock partitions and sub-partitions.

3. A process as claimed in 1, wherein the differential cost is computed as the sum of absolute differences (SAD).

4. A process as claimed in claim 1, wherein the differential cost is computed as the sum of squared differences SSD.

5. A process as claimed in claim 1, wherein the allowed macroblock partitioning modes are 16×16, 16×8, 8×16 and 8×8.

6. A process as claimed in claim 5, wherein the tile size is 4×4.

7. A process as claimed in 5, wherein the tile size is 8×8.

8. A process as claimed in claim 5, wherein each 8×8 macroblock partition can be subsequently sub-partitioned into 8×8, 8×4, 4×8 or 4×4 sub-partitions.

9. A process as claimed in claim 8, wherein the tile size is 4×4.

10. An apparatus having a plurality of computational units, said apparatus programmed or hard wired to perform the following process:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original macroblock and a reference macroblock whose origin is pointed by the motion vector into non-overlapping tiles, and computing a matrix of differential costs between the said tiles of the original macroblock and the corresponding tiles of the reference macroblock;
C) for each computed differential cost matrix, computing a partial cost vector whose elements are the partial differential costs of all the macroblock partitions and sub-partitions;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y-components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the macroblock partitioning and sub-partitioning modes;
G) in each computation unit, selecting the macroblock partitioning or sub-partitioning mode and the corresponding MVDs that yield the lowest total cost;
H) among the macroblock partitioning or sub-partitioning modes selected in step G by all computational units, selecting the macroblock partitioning or sub-partitioning mode and the corresponding MVDs that yield the lowest total cost.
and wherein said computational units are dedicated hardware units.

11. An apparatus as claimed in claim 10, wherein said programming or hard wiring controls said computer to divide said reference and original macroblocks up into tiles where the tile size is set to be the maximum size contained in all macroblock partitions and sub-partitions.

12. An apparatus as claimed in claim 10, wherein said programming or hard wiring controls said computer to calculate said differential cost by computing the sum of absolute differences (SAD).

13. An apparatus as claimed in claim 10, wherein said programming or hard wiring controls said computer to calculate said differential cost by computing the sum of squared differences (SSD).

14. An apparatus as claimed in claim 10, wherein said programming or hard wiring controls said computer to partition and sub-partition said reference macroblock using only allowed partitions or sub-partitions where the allowed macroblock partitioning modes are 16×16, 16×8, 8×16 and 8×8.

15. An apparatus as claimed in claim 14, wherein said programming or hard wiring controls said computer to divide said original and reference macroblocks into tiles of 4×4 size.

16. An apparatus as claimed in claim 14, wherein said programming or hard wiring controls said computer to divide said original and reference macroblocks into tiles of 8×8 size.

17. An apparatus as claimed in claim 1, wherein said programming or hard wiring controls said computer to divide said reference macroblocks into 16×16 or 8×8 partitions and wherein each 8×8 macroblock partition can be subsequently sub-partitioned into 8×8, 8×4, 4×8 or 4×4 sub-partitions.

18. An apparatus as claimed in claim 1, wherein said programming or hard wiring controls said computer to divide said reference macroblocks into 16×16 or 8×8 partitions and wherein each 8×8 macroblock partition can be subsequently sub-partitioned into 8×8, 8×4, 4×8 or 4×4 sub-partitions, and wherein the tile size is 4×4.

19. An apparatus having a plurality of computational units, said apparatus programmed to perform the following process:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original macroblock and a reference macroblock whose origin is pointed by the motion vector into non-overlapping tiles, and computing a matrix of differential costs between the said tiles of the original macroblock and the corresponding tiles of the reference macroblock;
C) for each computed differential cost matrix, computing a partial cost vector whose elements are the partial differential costs of all the macroblock partitions and sub-partitions;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the macroblock partitioning and sub-partitioning modes;
G) in each computation unit, selecting the macroblock partitioning or sub-partitioning mode and the corresponding MVDs that yield the lowest total cost;
H) among the macroblock partitioning or sub-partitioning modes selected in step G by all computational units, selecting the macroblock partitioning or sub-partitioning mode and the corresponding MVDs that yield the lowest total cost;
and wherein said computational units are programmable processors capable of performing operations on 4×4 matrix data types.

20. A computer-readable medium having stored thereon a set of computer-readable instructions which, when executed by a computer having a plurality of computational units cause said computer to carry out the following process:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original macroblock and a reference macroblock whose origin is pointed by the motion vector into non-overlapping tiles, and computing a matrix of differential costs between the said tiles of the original macroblock and the corresponding tiles of the reference macroblock;
C) for each computed differential cost matrix, computing a partial cost vector whose elements are the partial differential costs of all the macroblock partitions and sub-partitions;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the macroblock partitioning and sub-partitioning modes;
G) in each computation unit, selecting the macroblock partitioning or sub-partitioning mode and the corresponding MVDs that yield the lowest total cost;
H) among the macroblock partitioning or sub-partitioning modes selected in step G by all computational units, selecting the macroblock partitioning or sub-partitioning mode and the corresponding MVDs that yield the lowest total cost.

21. A motion estimation process comprising:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original 16×16 macroblock and a 16×16 reference macroblock whose origin is pointed to by the candidate motion vector into non-overlapping 4×4 tiles, and computing a Sum of Absolute Difference (SAD) cost for each said 4×4 tiles between said tiles of the original macroblock and the corresponding tiles of the reference macroblock;
C) for each computed 4×4 SAD matrix, computing a partial cost vector whose elements are the partial SAD costs of all the macroblock partitions and sub-partitions specified in the H.264 specification as it existed at the time of filing of this patent application with the addition to each said element of the estimated overhead of encoding the current candidate MVD;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the allowed macroblock partitioning and sub-partitioning modes specified in the H.264 specification as it existed at the time of filing of this patent application;
G) in each computation unit, selecting the macroblock partitioning or sub-partitioning mode and the corresponding MVD(s) that yield the lowest total cost;
H) among the macroblock partitioning or sub-partitioning modes selected in step G by all computational unit, selecting the macroblock partitioning or sub-partitioning mode and the corresponding MVD(s) that yield the lowest total cost.

22. An apparatus having a plurality of computational units, said apparatus programmed or hard wired to perform the following process:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original 16×16 macroblock and a 16×16 reference macroblock whose origin is pointed to by the candidate motion vector into non-overlapping 4×4 tiles, and computing a Sum of Absolute Difference (SAD) cost for each said 4×4 tiles between said tiles of the original macroblock and the corresponding tiles of the reference macroblock;
C) for each computed 4×4 SAD matrix, computing a partial cost vector whose elements are the partial SAD costs of all the macroblock partitions and sub-partitions specified in the H.264 specification as it existed at the time of filing of this patent application with the addition to each said element of the estimated overhead of encoding the current candidate MVD;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the allowed macroblock partitioning and sub-partitioning modes specified in the H.264 specification as it existed at the time of filing of this patent application;
G) in each computation unit, selecting the macroblock partitioning or sub-partitioning mode and the corresponding MVD(s) that yield the lowest total cost;
H) among the macroblock partitioning or sub-partitioning modes selected in step G by all computational unit, selecting the macroblock partitioning or sub-partitioning mode and the corresponding MVD(s) that yield the lowest total cost;
and wherein said computational units are dedicated hardware units.

23. An apparatus having a plurality of computational units, said apparatus programmed or hardwired to perform the following process:
A) dividing a motion vector search area up into a plurality of search sub-regions and assigning each search sub-region to one of a plurality of computation units of a parallel processing architecture computer having a plurality of computation units;
B) in each computational unit, for each of the candidate motion vectors in the search sub-region, dividing the original 16×16 macroblock and a 16×16 reference macroblock whose origin is pointed to by the candidate motion vector into non-overlapping 4×4 tiles, and computing a Sum of Absolute Difference (SAD) cost for each said 4×4 tiles between said tiles of the original macroblock and the corresponding tiles of the reference macroblock;
C) for each computed 4×4 SAD matrix, computing a partial cost vector whose elements are the partial SAD costs of all the macroblock partitions and sub-partitions specified in the H.264 specification as it existed at the time of filing of this patent application with the addition to each said element of the estimated overhead of encoding the current candidate MVD;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the current candidate MVD as the ones that realize the lowest partial costs for the corresponding partitions and sub-partitions
F) in each computational unit, once all the motion vectors in the search sub-region have been scanned, summing the relevant partial costs in said best cost vector of the lowest partial costs found so far to obtain a vector of total costs whose elements correspond to each of the allowed macroblock partitioning and sub-partitioning modes specified in the H.264 specification as it existed at the time of filing of this patent application;
G) in each computation unit, selecting the macroblock partitioning or sub-partitioning mode and the corresponding MVD(s) that yield the lowest total cost;
H) among the macroblock partitioning or sub-partitioning modes selected in step G by all computational unit, selecting the macroblock partitioning or sub-partitioning mode and the corresponding MVD(s) that yield the lowest total cost.
and wherein said computational units are programmable processors (clusters) capable of performing SIMD 4×4 operations.

24. The apparatus of claim 23, wherein the number of computational units is eight.

25. The apparatus of claim 23 wherein each computational unit is programmable.

26. A computer-readable medium having stored thereon computer-readable instructions which when executed by a parallel processing architecture computer cause said computer to carry out the following motion estimation process:
A) dividing a motion vector search area up into a plurality of search sub-regions and assigning each search sub-region to one of a plurality of computation units of a parallel processing architecture computer having a plurality of computation units;
B) in each computational unit, for each of the candidate MVD motion vectors in the search sub-region, computing a 4×4 matrix of SADs between the 16 corresponding 4×4 tiles of the original macroblock and a reference macroblock whose origin is pointed by the MVD motion vector;
C) for each computed 4×4 SAD matrix, computing a partial cost vector whose elements are the partial SAD costs of all the macroblock partitions and sub-partitions specified in the H.264 specification as it existed at the time of filing of this patent application with the addition to each said element of the estimated overhead of encoding the corresponding MVD motion vector for the partition or sub-partition represented by said element;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the origin of the partition or sub-partition which resulted in the lower cost which was substituted into said best-cost vector and to which said MVD motion vector pointsas the one that realize the lowest partial costs;
F) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions specified in the H.264 specification as it existed at the time of filing of this patent application;
G) in each computation unit, selecting the macroblock partition or sub-partition and the corresponding MVD motion vectors that yield the lowest total cost;
H) among the macroblock partition or sub-partitions selected in step G by all computational units, selecting the macroblock partition or sub-partition and the corresponding MVD motion vectors that yield the lowest total cost.

27. A parallel processing architecture computer having a plurality of computational units each capable of performing 4×4 matrix operations on integer data, said computer programmed with a program which causes said computational units to carry out the following motion estimation process:
A) dividing a motion vector search area up into a plurality of search sub-regions and assigning each search sub-region to one of a plurality of computation units units of a parallel processing architecture computer having a plurality of computation units;
B) in each computational unit, for each of the candidate MVD motion vectors in the search sub-region, computing a 4×4 matrix of SADs between the 16 corresponding 4×4 tiles of the original macroblock and a reference macroblock whose origin is pointed by the MVD motion vector;
C) for each computed 4×4 SAD matrix, computing a partial cost vector whose elements are the partial SAD costs of all the macroblock partitions and sub-partitions;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the origin of the partition or sub-partition which resulted in the lower cost which was substituted into said best-cost vector and to which said MVD motion vector points as the one that realizes the lowest partial costs;
F) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions;
G) in each computation unit, selecting the macroblock partition or sub-partition and the corresponding MVD motion vectors that yield the lowest total cost;
H) among the macroblock partition or sub-partitions selected in step G by all computational units, selecting the macroblock partition or sub-partition and the corresponding MVD motion vectors that yield the lowest total cost.

28. A motion estimation process comprising:
A) dividing a motion vector search area up into a plurality of search sub-regions and assigning each search sub-region to one of a plurality of computation units units of a parallel processing architecture computer having a plurality of computation units;
B) in each computational unit, for each of the candidate MVD motion vectors in the search sub-region, computing the absolute luminance difference at each pixel location of the original macroblock and a reference macroblock whose origin is pointed by the MVD motion vector;
C) for each computed set of absolute differences, computing a partial cost vector whose elements are the partial SAD costs of all the macroblock partitions and sub-partitions by summing the absolute differences at each pixel location of all the pixels within each element of the partition or sub-partition and recording the sum of the absolute differences within each element of a partition or sub-partition in a corresponding element of said partial cost vector, and adding to each element the estimated overhead of encoding the corresponding MVD motion vector for the partition or sub-partition represented by said element;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the origin of the partition or sub-partition which resulted in the lower cost which was substituted into said best-cost vector and to which said MVD motion vector points as the one that realize the lowest partial costs;
F) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions;
G) in each computation unit, selecting the macroblock partition or sub-partition and the corresponding MVD motion vectors that yield the lowest total cost;
H) among the macroblock partition or sub-partitions selected in step G by all computational units, selecting the macroblock partition or sub-partition(s) and the corresponding MVD motion vectors that yield the lowest total cost.

29. A computer-readable medium having stored thereon computer-readable instructions which, when executed by a parallel processing computer having multiple computation units, cause said computer to perform the following motion estimation process:
A) dividing a motion vector search area up into a plurality of search sub-regions and assigning each search sub-region to one of a plurality of computation units of a parallel processing architecture computer having a plurality of computation units;
B) in each computational unit, for each of the candidate MVD motion vectors in the search sub-region, computing the absolute luminance difference at each pixel location of the original macroblock and a reference macroblock whose origin is pointed by the MVD motion vector;
C) for each computed set of absolute differences, computing a partial cost vector whose elements are the partial SAD costs of all the macroblock partitions and sub-partitions application by summing the absolute differences at each pixel location of all the pixels within each element of the partition or sub-partition and recording the sum of the absolute differences within each element of a partition or sub-partition in a corresponding element of said partial cost vector, and adding to each element the estimated overhead of encoding the corresponding MVD motion vector for the partition or sub-partition represented by said element;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the origin of the partition or sub-partition which resulted in the lower cost which was substituted into said best-cost vector and to which said MVD motion vector points as the one that realize the lowest partial costs;
F) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions;
G) in each computation unit, selecting the macroblock partition or sub-partition and the corresponding MVD motion vectors that yield the lowest total cost;
H) among the macroblock partition or sub-partitions selected in step G by all computational units, selecting the macroblock partition or sub-partition(s) and the corresponding MVD motion vectors that yield the lowest total cost.

30. A parallel processing architecture computer having multiple computation units and programmed with one or more programs which, when executed by said computer cause said computer to perform the following motion estimation process:
A) dividing a motion vector search area up into a plurality of search sub-regions and assigning each search sub-region to one of a plurality of computation units of a parallel processing architecture computer having a plurality of computation units;
B) in each computational unit, for each of the candidate MVD motion vectors in the search sub-region, computing the absolute luminance difference at each pixel location of the original macroblock and a reference macroblock whose origin is pointed by the MVD motion vector;
C) for each computed set of absolute differences, computing a partial cost vector whose elements are the partial SAD costs of all the macroblock partitions and sub-partitions by summing the absolute differences at each pixel location of all the pixels within each element of the partition or sub-partition and recording the sum of the absolute differences within each element of a partition or sub-partition in a corresponding element of said partial cost vector, and adding to each element the estimated overhead of encoding the corresponding MVD motion vector for the partition or sub-partition represented by said element;
D) for each element of the computed partial cost vector, comparing said element to the corresponding element of a best cost vector of lowest partial costs found so far and updating the elements of said best cost vector whenever the newly computed partial cost is lower than the best cost so far in the corresponding element of said best cost vector;
E) for each of the updated partial costs, recording the x- and y- components of the origin of the partition or sub-partition which resulted in the lower cost which was substituted into said best-cost vector and to which said MVD motion vector points as the one that realize the lowest partial costs;
F) in each computational unit, once all the motion vectors in the search sub-region have been scanned, summing the relevant partial costs in said best cost vector of the lowest partial costs found so far to obtain a vector of total costs whose elements correspond to each of the macroblock partitions and sub-partitions specified in the H.264 specification as it existed at the time of filing of this patent application;
G) in each computation unit, selecting the macroblock partition or sub-partition and the corresponding MVD motion vectors that yield the lowest total cost;
H) among the macroblock partition or sub-partitions selected in step G by all computational units, selecting the macroblock partition or sub-partition(s) and the corresponding MVD motion vectors that yield the lowest total cost.

31. A process for doing motion estimation comprising:
A) at each of a plurality of pixel locations in a search area, where a pixel location can be a half pixel or a quarter pixel location as well as an integer pixel location, calculating the partial cost for all candidate partition and sub-partitions of a candidate reference macroblock having its origin at said pixel location and recording the partial cost results along with the MVD(s) which point to said origin of each partition or sub-partition;
B) finding the lowest cost partition or sub-partition(s) of all candidate reference macroblocks in said search area from the results recorded in step A and finding the corresponding MVD(s) of said lowest cost partition or sub-partition(s) selected in this step B;
C) encoding a macroblock using the results of step B.

32. A computer-readable medium having stored thereon computer-readable instructions which, when executed by a computer, cause said computer to perform the following process for motion estimation:
A) at each of a plurality of pixel locations in a search area, where a pixel location can be a half pixel or a quarter pixel location as well as an integer pixel location, calculating the partial cost for all candidate partition and sub-partitions of a candidate reference macroblock having its origin at said pixel location and recording the partial cost results along with the MVD(s) which point to said origin of each partition or sub-partition;
B) finding the lowest cost partition or sub-partition(s) of all candidate reference macroblocks in said search area from the results recorded in step A and finding the corresponding MVD(s) of said lowest cost partition or sub-partition(s) selected in this step B;
C) encoding a macroblock using the results of step B.

33. A computer programmed with instructions which, when executed by said computer cause said computer to perform the following motion estimation process:
A) at each of a plurality of pixel locations in a search area, where a pixel location can be a half pixel or a quarter pixel location as well as an integer pixel location, calculating the partial cost for all candidate partition and sub-partitions of a candidate reference macroblock having its origin at said pixel location and recording the partial cost results along with the MVD(s) which point to said origin of each partition or sub-partition;
B) finding the lowest cost partition or sub-partition(s) of all candidate reference macroblocks in said search area from the results recorded in step A and finding the corresponding MVD(s) of said lowest cost partition or sub-partition(s) selected in this step B;
C) encoding a macroblock using the results of step B.

34. The computer of claim 33 wherein said computer has a plurality of programmable computation units and wherein said program causes said computer to perform step A by assigning a dedicated computation unit to each said partition or sub-partition of a candidate reference macroblock and use that computation unit to calculate the partial cost for said partition or sub-partition.

35. The computer of claim 33 wherein said program causes said computer to cause one or more computation units to calculate the partial cost of each partition or sub-partition as the total SAD and MVD cost of the partition or sub-partition, and to compare the total SAD and MVD costs of each partition or sub-partition, as calculated by said dedicated computation units, and to select the partition or sub-partition(s) with the lowest total cost and the MVD(s) which point to the lowest total cost partition or sub-partitions.

36. The computer of claim 33 wherein said program causes said computer to partition and sub-partion each candidate reference macroblock using the partitions and sub-partitions defined in the H.264 standard as it existed at the time this patent application was filed and then compute the total SAD and MVD overhead cost of each partition and sub-partition of an 8×8 partition, and select the lowest total cost sub-partition of each said 8×8 partition and the MVD(s) which point to these lowest cost sub-partitions if none of the 16×16 or 16×8 or 8×16 partitions defined in the H.264 specification are the lowest total cost partition of the 16×16 reference macroblock.
